(19) United States
(12) Patent Application Publication
(10) Pub. No.: US 2026/0292690 A1
(43) Pub. Date: Sep. 24, 2026

(54) SYSTEM AND METHOD FOR CONFIGURING UPLINK (UL) CONTROL SIGNALING AND UL TIMING ADJUSTMENT BY A MULTI-TRANSCEIVER DEVICE

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Kazuki TAKEDA, Tokyo (JP); Igor GUTMAN, Hod HaSharon (IL); Junyi LI, Greentown, PA (US); Tao LUO, San Diego, CA (US)

(21) Appl. No.: 19/085,756

(22) Filed: Mar. 20, 2025

(51) Int. Cl. H04W 52/02; H04W 56/00

(52) U.S. Cl. CPC H04W 52/0235; H04W 56/0045

(57) ABSTRACT

Various aspects of the present disclosure generally relate to wireless communication, and to supporting and configuring uplink (UL) control signaling for a multi-transceiver wireless device, such as a user equipment (UE). For example, a UE may include a transceiver and a low-power (LP) transceiver, and the UE may be configured to communicate via the transceiver when operating in an active mode and to communicate via the LP transceiver when operating in an LP mode. The UE may receive a configuration via the transceiver and from a network node, and the configuration may indicate one or more transmit parameters associated with the LP transceiver. When operating in the LP mode, the UE may transmit, via the LP receiver, a UL transmission signal that is selected, in accordance with the transmit parameters, a message type, and UL control information, from one or more predefined transmission signals.

### FIELD OF THE DISCLOSURE

Aspects of the present disclosure relate generally to wireless communication systems, and more particularly, to a configuration of a multi-transceiver device for uplink control signaling and uplink timing adjustment in wireless communication systems.

### BACKGROUND

Wireless communications systems are widely deployed to provide various types of services such as voice, video, packet data, messaging, broadcast, and other types of traffic. The services may include unicast, multicast, and/or broadcast services, among other examples. Typical wireless communication systems may support multiple-access radio access technologies and include a number of base stations or network nodes, each supporting communication for multiple communication devices, which may be otherwise known as user equipment (UE). These systems may be capable of supporting communication with multiple users by sharing available system resources (such as time domain resources, frequency domain resources, spatial domain resources, and device transmit power, among other examples). These systems may employ multiple-access technologies such as code division multiple access (CDMA) technology, time division multiple access (TDMA) technology, frequency division multiple access (FDMA) technology, orthogonal frequency division multiple access (OFDMA) technology, discrete Fourier transform spread orthogonal frequency division multiplexing (DFT-S-OFDM) technology, single-carrier frequency division multiple access (SC-FDMA) technology, and time division synchronous code division multiple access (TD-SCDMA) technology.

The above multiple-access technologies have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, carrier aggregation, high-precision positioning, and/or radio frequency (RF) sensing, among other examples. As the demand for mobile broadband access continues to increase, further improvements in NR may be implemented, and other radio access technologies, such as 6G, may be introduced to further advance mobile broadband evolution.

As wireless communication technology advances, wireless communication devices are expected to support increasingly complex applications and functionality. One challenge associated with supporting such advanced functionality is an increase in power consumption of wireless communication devices. Mobile devices, such as UEs, are typically powered by a battery or other limited power source to enable the device to be moved between locations without being connected to a fixed power source. Thus, if a mobile device executes an application that consumes a significant amount of power, the operational time of the mobile device before the battery is recharged is decreased, which can degrade user experience. As such, power consumption at mobile devices is typically an important design consideration in wireless communication systems. Some techniques to conserve power include configuring mobile devices to enter into low-power or sleep modes to conserve power during time periods of low activity. However, these low-power modes typically include deactivating communication circuitry, such as transceivers, to conserve power. Deactivating the transceiver can prevent the mobile device from providing uplink control information and status information until a transition out of the low-power mode, which can delay the use of this control information or status information to adjust wireless communications between the mobile device and a network node to compensate for channel conditions or to perform requested communications. In some situations, this can result in the mobile device not receiving one or more wireless communications while in the low-power mode, resulting in the mobile device performing more communications with the transceiver activated, which consumes additional power.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Some aspects described herein relate to a user equipment (UE) for wireless communication. The UE includes a processing system that includes one or more processors and one or more memories that store code and are coupled with the one or more processors. The processing system is configured to cause the UE to receive, via a primary transceiver of the UE and from a network node, a configuration associated with a secondary transceiver of the UE. The processing system is further configured to identify, in accordance with the configuration, a first parameter value that indicates a message type and a second parameter value that indicates uplink (UL) control information. Further, the processing system is configured to transmit, via the secondary transceiver, to the network node and during a wake-up signal (WUS) monitoring period, a UL transmission signal selected, in accordance with the first parameter value and the second parameter value, from one or more predefined transmission signals.

Some aspects described herein relate to a method of wireless communication performed by a UE. The method includes receiving, via a primary transceiver of the UE and from a network node, a configuration associated with a secondary transceiver of the UE. The method further includes identifying, in accordance with the configuration, a first parameter value that indicates a message type and a second parameter value that indicates UL control information. Additionally, the method includes transmitting, via the secondary transceiver, to the network node and during a WUS monitoring period, a UL transmission signal selected, in accordance with the first parameter value and the second parameter value, from one or more predefined transmission signals.

Some aspects described herein relate to an apparatus. The apparatus includes means for receiving, via a primary transceiver and from a network node, a configuration associated with a secondary transceiver. The apparatus further includes means for identifying, in accordance with the configuration, a first parameter value that indicates a message type and a second parameter value that indicates UL control information. Additionally, the apparatus includes means for transmitting, via the secondary transceiver, to the network node and during a WUS monitoring period, a UL transmission signal selected, in accordance with the first parameter value and the second parameter value, from one or more predefined transmission signals.

Some aspects described herein relate to a non-transitory computer-readable medium that stores instructions that, when executed by one or more processors, cause the one or more processors to perform operations. The operations include receiving, via a primary transceiver and from a network node, a configuration associated with a secondary transceiver. The operations further include identifying, in accordance with the configuration, a first parameter value that indicates a message type and a second parameter value that indicates UL control information. Additionally, the operations include transmitting, via the secondary transceiver, to the network node and during a WUS monitoring period, a UL transmission signal selected, in accordance with the first parameter value and the second parameter value, from one or more predefined transmission signals.

Some aspects described herein relate to a network node for wireless communication. The network node includes a processing system that includes one or more processors and one or more memories that store code and are coupled with the one or more processors. The processing system is configured to cause the network node to transmit, to a UE that includes a primary transceiver and a secondary transceiver, a configuration associated with the secondary transceiver of the UE. The configuration indicates multiple parameters associated with the secondary transceiver and a WUS monitoring period. The processing system is further configured to receive, from the UE and during the WUS monitoring period, a UL transmission signal in accordance with a first parameter value and a second parameter value. The UL transmission signal is included in one or more predefined transmission signals, the first parameter value indicating a message type and the second parameter value indicating UL control information.

Some aspects described herein relate to a method of wireless communication performed by a network node. The method includes transmitting, to a UE that includes a primary transceiver and a secondary transceiver, a configuration associated with the secondary transceiver of the UE. The configuration indicates multiple parameters associated with the secondary transceiver and a WUS monitoring period. The method further includes receiving, from the UE and during the WUS monitoring period, a UL transmission signal in accordance with a first parameter value and a second parameter value. The UL transmission signal is included in one or more predefined transmission signals, the first parameter value indicating a message type and the second parameter value indicating UL control information.

Some aspects described herein relate to an apparatus. The apparatus includes means for transmitting, to a UE that includes a primary transceiver and a secondary transceiver, a configuration associated with the secondary transceiver of the UE. The configuration indicates multiple parameters associated with the secondary transceiver and a WUS monitoring period. The apparatus further includes means for receiving, from the UE and during the WUS monitoring period, a UL transmission signal in accordance with a first parameter value and a second parameter value. The UL transmission signal is included in one or more predefined transmission signals, the first parameter value indicating a message type and the second parameter value indicating UL control information.

Some aspects described herein relate to a non-transitory computer-readable medium that stores instructions that, when executed by one or more processors, cause the one or more processors to perform operations. The operations include transmitting, to a UE that includes a primary transceiver and a secondary transceiver, a configuration associated with the secondary transceiver of the UE. The configuration indicates multiple parameters associated with the secondary transceiver and a WUS monitoring period. The operations further include receiving, from the UE and during the WUS monitoring period, a UL transmission signal in accordance with a first parameter value and a second parameter value. The UL transmission signal is included in one or more predefined transmission signals, the first parameter value indicating a message type and the second parameter value indicating UL control information.

Some aspects described herein relate to a UE for wireless communication. The UE includes a processing system that includes one or more processors and one or more memories that store code and are coupled with the one or more processors. The processing system is configured to cause the UE to receive, via a secondary transceiver of the UE and from a network node, during a WUS monitoring period when a primary transceiver of the UE is powered down, a control signaling indicator that indicates whether control signaling is to be communicated by the network node. The processing system is further configured to receive, via the secondary transceiver and from the network node, during the WUS monitoring period and in accordance with the control signaling indicator indicating that the control signaling is to be communicated, a DL control signal indicating a timing advance command. Additionally, the processing system is configured to identify, in accordance with a configuration associated with the secondary transceiver, a timing advance parameter value associated with a parameter value of the DL control signal. Further, the processing system is configured to adjust, in accordance with the timing advance parameter value, a transmission time associated with one or more UL transmission signals via the secondary transceiver and during the WUS monitoring period.

Some aspects described herein relate to a method of wireless communication performed by a UE. The method includes receiving, via a secondary transceiver of the UE and from a network node, during a WUS monitoring period when a primary transceiver of the UE is powered down, a control signaling indicator that indicates whether control signaling is to be communicated by the network node. The method further includes receiving, via the secondary transceiver and from the network node, during the WUS monitoring period and in accordance with the control signaling indicator indicating that the control signaling is to be communicated, a DL control signal indicating a timing advance command. Additionally, the method includes identifying, in accordance with a configuration associated with the secondary transceiver, a timing advance parameter value associated with a parameter value of the DL control signal. Further, the method includes adjusting, in accordance with the timing advance parameter value, a transmission time associated with one or more UL transmission signals via the secondary transceiver and during the WUS monitoring period.

Some aspects described herein relate to an apparatus. The apparatus includes means for receiving, via a secondary transceiver and from a network node, during a WUS monitoring period when a primary transceiver is powered down, a control signaling indicator that indicates whether control signaling is to be communicated by the network node. The apparatus further includes means for receiving, via the secondary transceiver and from the network node, during the WUS monitoring period and in accordance with the control signaling indicator indicating that the control signaling is to be communicated, a DL control signal indicating a timing advance command. Additionally, the apparatus includes means for identifying, in accordance with a configuration associated with the secondary transceiver, a timing advance parameter value associated with a parameter value of the DL control signal. Further, the apparatus includes means for adjusting, in accordance with the timing advance parameter value, a transmission time associated with one or more UL transmission signals via the secondary transceiver and during the WUS monitoring period.

Some aspects described herein relate to a non-transitory computer-readable medium that stores instructions that, when executed by one or more processors, cause the one or more processors to perform operations. The operations include receiving, via a secondary transceiver and from a network node, during a WUS monitoring period when a primary transceiver is powered down, a control signaling indicator that indicates whether control signaling is to be communicated by the network node. The operations further include receiving, via the secondary transceiver and from the network node, during the WUS monitoring period and in accordance with the control signaling indicator indicating that the control signaling is to be communicated, a DL control signal indicating a timing advance command. Additionally, the operations include identifying, in accordance with a configuration associated with the secondary transceiver, a timing advance parameter value associated with a parameter value of the DL control signal. Further, the operations include adjusting, in accordance with the timing advance parameter value, a transmission time associated with one or more UL transmission signals via the secondary transceiver and during the WUS monitoring period.

Some aspects described herein relate to a network node for wireless communication. The network node includes a processing system that includes one or more processors and one or more memories that store code and are coupled with the one or more processors. The processing system is configured to cause the network node to receive, from a UE and during a WUS monitoring period, a PRACH preamble. The processing system is further configured to cause the network node to transmit, to the UE, during the WUS monitoring period in accordance with receipt of the PRACH preamble, a control signaling indicator that indicates whether control signaling is to be communicated. Further, the processing system is configured to cause the network node to transmit, to the UE, during the WUS monitoring period in accordance with the control signaling indicator indicating that the control signaling is to be communicated, a DL control signal indicating a timing advance command and an associated timing advance parameter value.

Some aspects described herein relate to a method of wireless communication performed by a network node. The method includes receiving, from a UE and during a WUS monitoring period, a PRACH preamble. The method further includes transmitting, to the UE, during the WUS monitoring period in accordance with receipt of the PRACH preamble, a control signaling indicator that indicates whether control signaling is to be communicated. Further, the method includes transmitting, to the UE, during the WUS monitoring period in accordance with the control signaling indicator indicating that the control signaling is to be communicated, a DL control signal indicating a timing advance command and an associated timing advance parameter value.

Some aspects described herein relate to an apparatus. The apparatus includes means for receiving, from a UE and during a WUS monitoring period, a PRACH preamble. The apparatus further includes means for transmitting, to the UE, during the WUS monitoring period in accordance with receipt of the PRACH preamble, a control signaling indicator that indicates whether control signaling is to be communicated. Further, the apparatus includes means for transmitting, to the UE, during the WUS monitoring period in accordance with the control signaling indicator indicating that the control signaling is to be communicated, a DL control signal indicating a timing advance command and an associated timing advance parameter value.

Some aspects described herein relate to a non-transitory computer-readable medium that stores instructions that, when executed by one or more processors, cause the one or more processors to perform operations. The operations include receiving, from a UE and during a WUS monitoring period, a PRACH preamble. The operations further include transmitting, to the UE, during the WUS monitoring period in accordance with receipt of the PRACH preamble, a control signaling indicator that indicates whether control signaling is to be communicated. Further, the operations include transmitting, to the UE, during the WUS monitoring period in accordance with the control signaling indicator indicating that the control signaling is to be communicated, a DL control signal indicating a timing advance command and an associated timing advance parameter value.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, methods, and computer-readable media.

### BRIEF DESCRIPTION OF THE DRAWINGS

A further understanding of the nature and advantages of the present disclosure may be realized by reference to the following drawings. In the appended figures, similar components or features may have the same reference label and designations. Further, various components of the same type may be distinguished by following the reference label by a dash and a second label that distinguishes among the similar components, or by following the reference label with a letter. If just the first reference label is used in the specification, the description is applicable to any one of the similar components having the same first reference label irrespective of the second reference label or letter.

FIG. 1 is a block diagram illustrating details of an example wireless communication network in accordance with the present disclosure.

FIG. 2 is a block diagram illustrating examples of a network node and a user equipment (UE) in accordance with the present disclosure.

FIG. 3 is a block diagram illustrating an example disaggregated base station architecture in accordance with the present disclosure.

FIG. 4 is a block diagram illustrating an example of a wireless communication system that supports configuring uplink (UL) control signaling by a multi-transceiver UE in accordance with the present disclosure.

FIG. 5 is a flow diagram illustrating an example of a process that supports UL control signaling by the multi-transceiver UE of FIG. 4 in accordance with the present disclosure.

FIG. 6 is a block diagram illustrating an example of a multi-transceiver UE that supports UL control signaling in accordance with the present disclosure.

FIG. 7 is a block diagram illustrating an example of a UE capability message in accordance with the present disclosure.

FIG. 8 is a block diagram illustrating an example of a configuration associated with a low-power (LP) transceiver in accordance with the present disclosure.

FIG. 9 is a diagram illustrating an example of selecting predetermined transmission signal samples for use in generating a UL control signal by a multi-transceiver UE in accordance with the present disclosure.

FIG. 10 is a ladder diagram illustrating example operations that support transmission of a UL control signal by a multi-transceiver UE in accordance with the present disclosure.

FIG. 11 is a ladder diagram illustrating example operations that support UL timing adjustment by a multi-transceiver UE in accordance with the present disclosure.

FIG. 12 is a flow diagram illustrating an example process that supports UL control signaling by a multi-transceiver device in accordance with the present disclosure.

FIG. 13 is a flow diagram illustrating an example process that supports UL timing adjustment by a multi-transceiver device in accordance with the present disclosure.

FIG. 14 is a block diagram of an example UE that supports UL control signaling and UL timing adjustment by a multi-transceiver device in accordance with the present disclosure.

FIG. 15 is a flow diagram illustrating an example process that supports configuring UL signaling by a multi-transceiver device in accordance with the present disclosure.

FIG. 16 is a flow diagram illustrating an example process that supports configuring UL timing adjustment by a multi-transceiver device in accordance with the present disclosure.

FIG. 17 is a block diagram of an example network node that supports configuring UL control signaling and UL timing adjustment by a multi-transceiver device in accordance with the present disclosure.

### DETAILED DESCRIPTION

Various aspects of the disclosure are described more fully hereinafter with reference to the accompanying drawings. This disclosure may, however, be embodied in many different forms and is not to be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

The present disclosure provides systems, apparatus, methods, and computer-readable media for supporting uplink (UL) control signaling and UL timing adjustment for multi-transceiver devices of wireless communication systems. Some aspects more specifically relate to configuring a user equipment (UE) that includes a primary (or “main”) transceiver as well as a low-power (LP) transceiver to perform UL control signaling while the UE is operating in an LP mode in which the primary transceiver is deactivated and the LP transceiver is active or powered on. As used herein, an “LP transceiver” refers to a transceiver that is capable of processing and communicating a limited number of signals, typically within a limited bandwidth, such that the LP transceiver has a lower power consumption rate than the primary transceiver. To configure the UE to transmit one or more types of UL control signaling during one or more upcoming wake-up signal (WUS) monitoring periods, a network node may transmit a configuration to the UE while the UE is in a normal operating mode, which may also be referred to as an active mode, during which the UE uses its primary transceiver for communication. The UE receives the configuration using the primary transceiver and identifies one or more transmit parameters indicated by the configuration, where the transmit parameters are associated with the LP transceiver and a particular WUS monitoring period. For example, the predefined transmission signals may include or correspond to relatively less complex signals that are capable of being transmitted by the LP transceiver and that are associated with one or more parameters that vary between at least some of the predefined transmission signals. The UE may select the appropriate predefined transmission signal in accordance with an association or mapping, indicated by the configuration, between the transmit parameter values and a message type and UL control information to be indicated by the UL control signaling. Such UL control information may typically be sent by the UE via a medium access control (MAC) control element (MAC CE) during the normal operating mode.

Multi-transceiver devices described herein, such as the UE, may be capable of supporting various types of UL control signaling while operating in the LP mode, and each of the types of control signaling may be configured by the network node through the selection of the transmit parameters indicated by the configuration. In some examples, the UL control signaling sent by the UE via the LP transceiver includes a buffer status report that indicates to the network node an amount of UL data to be sent using requested UL resources by the UE. As another example, the UL control signaling can include a power headroom report that indicates an amount of transmission power that is available for use by the UE in addition to the power represented by a current transmission. In some other examples, the UL control signaling may include or represent a physical random access channel (PRACH) preamble that can be used by the network node to send a timing advance command to enable the UE to adjust transmission timing of UL signaling while operating in the LP mode. In such examples, the network node may transmit a control signaling indicator that indicates whether additional control signaling is to be communicated. The control signaling indicator may include or correspond to a bit or a flag in a WUS sent by the network node. If the network node determines a timing advance parameter value to be configured at the UE, the control signaling indicator indicates that additional control signaling is to be communicated. The network node may subsequently send a downlink (DL) control signal that indicates a timing advance command and the associated timing advance parameter value. The UE may adjust a transmission time of UL transmission signals in accordance with the timing advance parameter value to compensate for delay associated with signal propagation within a wireless channel between the network node and the UE.

Particular implementations of the subject matter described in this disclosure can be implemented to realize one or more of the following potential advantages. In some aspects, the present disclosure provides techniques for configuring UL control signaling and UL timing adjustment that reduces power consumption at multi-transceiver devices. For example, by configuring a multi-transceiver device, such as a UE, to transmit particular types of UL control signaling using an LP transceiver, the multi-transceiver device can operate in an LP mode associated with a reduced rate of power consumption and still be capable of transmitting UL control signaling and receiving DL control signaling while in the LP mode. Instead of transitioning to the active mode associated with a larger rate of power consumption, the UE may transmit UL control signaling via the LP transceiver while remaining in the LP mode, either until an instruction from the network node or an end of a WUS monitoring period, which decreases the power consumption of the UE as compared to transitioning to the active mode to transmit UL control signaling. Additionally, enabling the UE to transmit the UL control signaling can provide the network node with information to enable additional functionality or to improve communications within the wireless network without waiting until an end of the WUS monitoring period. For example, by transmitting a UL control signal that indicates a buffer status report or a power headroom report, the UE may provide control information that can be used by the network node to schedule an UL grant for the UE and/or to adjust downlink transmit parameters such as a modulation and coding scheme (MCS) or a selected transmit beam. Additionally, or alternatively, the network node may provide the UE with a timing advance parameter value that the UE can use to adjust UL transmission timing while operating in the LP mode to compensate for signal propagation delay within a wireless channel between the UE and the network node. Such operations may be performed at least partially while the UE is operating in the LP mode, which reduces power consumption at the UE compared to operating in the normal operating mode while also improving communications within the wireless network, such as by reducing retransmissions due to errors, which can improve latency and bandwidth within the wireless network.

This disclosure relates generally to providing or participating in authorized shared access between two or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, long term evolution (LTE) networks, Global System for Mobile Communications (GSM) networks, 5th Generation (5G) or new radio (NR) networks (sometimes referred to as “5G NR” networks, systems, or devices), as well as other communications networks. As described herein, the terms “networks” and “systems” may be used interchangeably.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV). 5G NR networks contemplate diverse deployments, diverse spectrum, and diverse services and devices that may be implemented using an OFDM-based unified, air interface.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 gigahertz (GHz) FDD or TDD implementations, subcarrier spacing may occur with 15 kilohertz (kHz), for example over 1, 5, 10, 20 megahertz (MHz), and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases. For clarity, certain aspects of the present disclosure may be described below with reference to example 5G NR implementations or in a 5G-centric way, and 5G terminology may be used as illustrative examples in portions of the description below; however, the description is not intended to be limited to 5G applications.

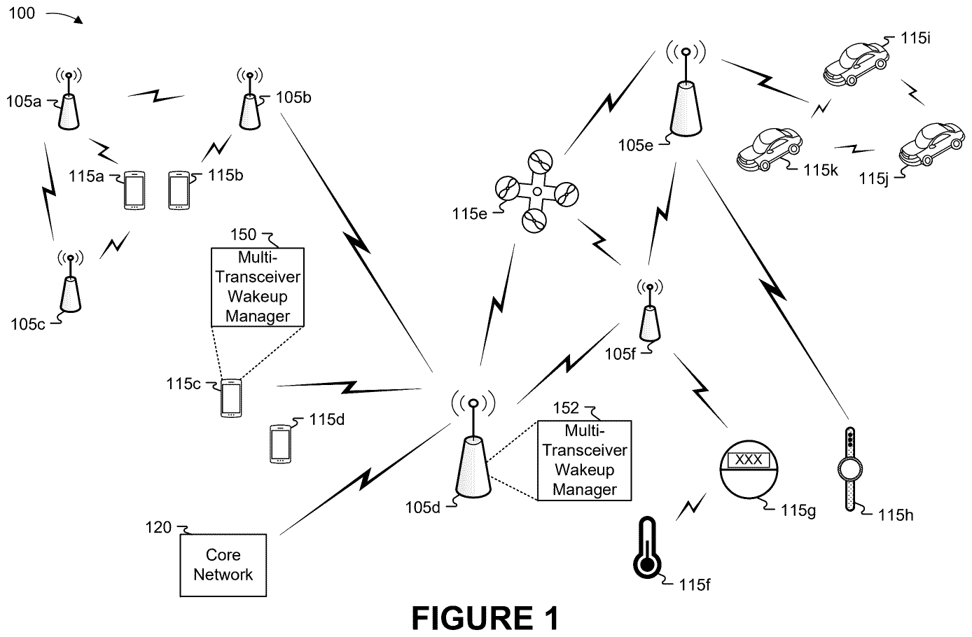

FIG. 1 is a block diagram illustrating details of an example wireless communication network 100 in accordance with the present disclosure. The wireless communication network 100 may, for example, be or include elements of a 5G (or NR) network or a 6G network, among other examples. As appreciated by those skilled in the art, components appearing in FIG. 1 are likely to have related counterparts in other network arrangements including, for example, cellular-style network arrangements and non-cellular-style-network arrangements, such as device-to-device, peer-to-peer, or ad hoc network arrangements, among other examples.

The wireless communication network 100 illustrated in FIG. 1 includes multiple network nodes 105, also referred to as network entities, and multiple user equipments (UEs) 115. A network node may be a station that communicates with UEs and may be referred to as a base station, an evolved node B (eNB), a next generation eNB (gNB), an access point, and the like. Each network node 105 may provide communication coverage for a particular geographic area. In 3GPP, the term “cell” can refer to this particular geographic coverage area of a network node or a network node subsystem serving the coverage area, depending on the context in which the term is used. In implementations of the wireless communication network 100 herein, the network nodes 105 may be associated with a same operator or different operators, such as the wireless communication network 100 may include a plurality of operator wireless networks. In some examples, an individual network node 105 or UE 115 may be operated by more than one network operating entity. In some other examples, each network node 105 and UE 115 may be operated by a single network operating entity.

The network nodes 105 and the UEs 115 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR 4a FR4-1,FR 4, and FR 5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, in accordance with user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 105 may include one or more devices, components, or systems that enable communication between a UE 115 and one or more devices, components, or systems of the wireless communication network 100. A network node 105 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 105 may be implemented as a single physical node (for example, a single physical structure) or may be implemented as two or more physical nodes (for example, two or more distinct physical structures). For example, a network node 105 may be a device or system that implements part of a radio protocol stack, a device or system that implements a full radio protocol stack (such as a full gNB protocol stack), or a collection of devices or systems that collectively implement the full radio protocol stack. For example, and as shown, a network node 105 may be an aggregated network node (having an aggregated architecture), meaning that the network node 105 may implement a full radio protocol stack that is physically and logically integrated within a single node (for example, a single physical structure) in the wireless communication network 100. For example, an aggregated network node 105 may consist of a single standalone base station or a single TRP that uses a full radio protocol stack to enable or facilitate communication between a UE 115 and a core network 120 of the wireless communication network 100.

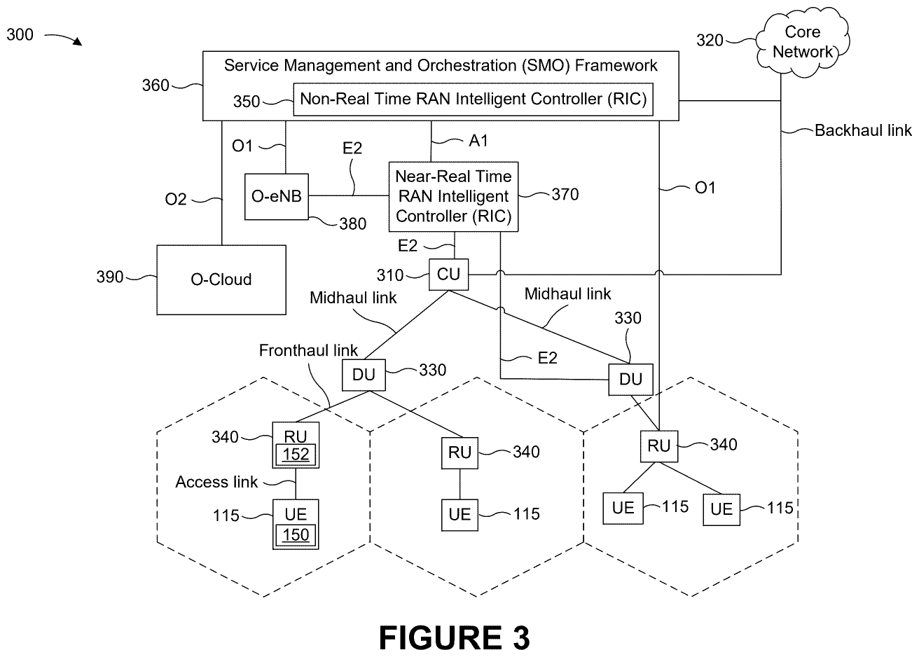

Alternatively, a network node 105 may be a disaggregated network node (sometimes referred to as a disaggregated base station), meaning that the network node 105 may implement a radio protocol stack that is physically distributed and/or logically distributed among two or more nodes in the same geographic location or in different geographic locations. For example, a disaggregated network node may have a disaggregated architecture, as further described herein with reference to FIG. 3. In some deployments, disaggregated network nodes 105 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 105 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 115, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 115.

In some aspects, a single network node 105 may include a combination of one or more CUs, one or more DUs, and/or one or more RUs. Additionally, or alternatively, a network node 105 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 105 (for example, a base station, an RU, or a TRP) may provide communication coverage for a particular geographic area. In the 3GPP, the term “cell” can refer to a coverage area of a network node 105 or to a network node 105 itself, depending on the context in which the term is used. A network node 105 may support one or multiple (for example, three) cells. In some examples, a network node 105 may provide communication coverage for a macro cell, a pico cell, a femto cell, or another type of cell. A macro cell may cover a relatively large geographic area (for example, several kilometers in radius) and may allow unrestricted access by UEs 115 with service subscriptions. A pico cell may cover a relatively small geographic area and may allow unrestricted access by UEs 115 with service subscriptions. A femto cell may cover a relatively small geographic area (for example, a home) and may allow restricted access by UEs 115 having association with the femto cell (for example, UEs 115 in a closed subscriber group (CSG)). A network node 105 for a macro cell may be referred to as a macro network node. A network node 105 for a pico cell may be referred to as a pico network node. A network node 105 for a femto cell may be referred to as a femto network node or an in-home network node. In some examples, a cell may not necessarily be stationary. For example, the geographic area of the cell may move according to the location of an associated mobile network node 105 (for example, a train, a satellite base station, an unmanned aerial vehicle, or an NTN network node).

The wireless communication network 100 may be a heterogeneous network that includes network nodes 105 of different types, such as macro network nodes, pico network nodes, femto network nodes, relay network nodes, aggregated network nodes, and/or disaggregated network nodes, among other examples. In the example shown in FIG. 1, network nodes 105d and 105e are regular macro network nodes, while network nodes 105a-105c are macro network nodes enabled with one of 3 dimension (3D), full dimension (FD), or massive MIMO. Network nodes 105a-105c take advantage of their higher dimension MIMO capabilities to exploit 3D beamforming in both elevation and azimuth beamforming to increase coverage and capacity. Network node 105f is a small cell network node which may be a home node or portable access point. A network node may support one or multiple cells, such as two cells, three cells, four cells, and the like. Various different types of network nodes 105 may generally transmit at different power levels, serve different coverage areas, and/or have different impacts on interference in the wireless communication network 100 than other types of network nodes 105. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 105 may be, may include, or may operate as an RU, a TRP, or a base station that communicates with one or more UEs 115 via a radio access link (which may be referred to as a “Uu” link). The radio access link may include a downlink and an uplink. “Downlink” (or “DL”) refers to a communication direction from a network node 105 to a UE 115, and “uplink” (or “UL”) refers to a communication direction from a UE 115 to a network node 105. Downlink channels may include one or more control channels and one or more data channels. A downlink control channel may be used to transmit downlink control information (DCI) (for example, scheduling information, reference signals, and/or configuration information) from a network node 105 to a UE 115. A downlink data channel may be used to transmit downlink data (for example, user data associated with a UE 115) from a network node 105 to a UE 115. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 115 to a network node 105. An uplink data channel may be used to transmit uplink data (for example, user data associated with a UE 115) from a UE 115 to a network node 105. Uplink control channels may include one or more physical uplink control channels (PUCCHs), and uplink data channels may include one or more physical uplink shared channels (PUSCHs). The downlink and the uplink may each include a set of resources on which the network node 105 and the UE 115 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 115. A UE 115 may be configured with both an uplink BWP and a downlink BWP (where the uplink BWP and the downlink BWP may be the same BWP or different BWPs). A BWP may be dynamically configured (for example, by a network node 105 transmitting a DCI configuration to the one or more UEs 115) and/or reconfigured, which means that a BWP can be adjusted in real-time (or near-real-time) in accordance with changing network conditions in the wireless communication network 100 and/or in accordance with the specific requirements of the one or more UEs 115. This enables more efficient use of the available frequency domain resources in the wireless communication network 100 because fewer frequency domain resources may be allocated to a BWP for a UE 115 (which may reduce the quantity of frequency domain resources that a UE 115 is required to monitor), leaving more frequency domain resources to be spread across multiple UEs 115. Thus, BWPs may also assist in the implementation of lower-capability UEs 115 by facilitating the configuration of smaller bandwidths for communication by such UEs 115.

As described above, in some aspects, the wireless communication network 100 may be, may include, or may be included in, an IAB network. In an IAB network, at least one network node 105 is an anchor network node that communicates with the core network 120. An anchor network node 105 may also be referred to as an IAB donor (or “IAB-donor”). The anchor network node 105 may connect to the core network 120 via a wired backhaul link. For example, an Ng interface of the anchor network node 105 may terminate at the core network 120. Additionally, or alternatively, an anchor network node 105 may connect to one or more devices of the core network 120 that provide a core access and mobility management function (AMF). An IAB network also generally includes multiple non-anchor network nodes 105, which may also be referred to as relay network nodes or simply as IAB nodes (or “IAB-nodes”). Each non-anchor network node 105 may communicate directly with the anchor network node 105 via a wireless backhaul link to access the core network 120, or may communicate indirectly with the anchor network node 105 via one or more other non-anchor network nodes 105 and associated wireless backhaul links that form a backhaul path to the core network 120. Some anchor network nodes 105 or other non-anchor network nodes 105 may also communicate directly with one or more UEs 115 via wireless access links that carry access traffic. In some examples, network resources for wireless communication (such as time resources, frequency resources, and/or spatial resources) may be shared between access links and backhaul links.

The wireless communication network 100 may support synchronous or asynchronous operation. For synchronous operation, the network nodes may have similar frame timing, and transmissions from different network nodes may be approximately aligned in time. For asynchronous operation, the network nodes may have different frame timing, and transmissions from different network nodes may not be aligned in time. In some scenarios, networks may be enabled or configured to handle dynamic switching between synchronous or asynchronous operations.

The UEs 115 are physically dispersed throughout the wireless communication network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile phone, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A UE 115 may additionally be an “Internet of Things” (IoT) or “Internet of Everything” (IoE) device, an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples. The UEs 115 may also include digital home or smart home devices, such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless communication network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access the wireless communication network 100.

A mobile apparatus, such as the UEs 115, may be able to communicate with any type of the network nodes, whether macro network nodes, pico network nodes, femto network nodes, macro base stations, pico base stations, femto base stations, relays, and the like. In FIG. 1, a communication link (represented as a lightning bolt) indicates wireless transmissions between a UE and a serving network node, which is a network node designated to serve the UE on the downlink or uplink, wireless transmissions between network nodes, and backhaul transmissions between network nodes. Backhaul communication between network nodes of the wireless communication network 100 may occur using wired or wireless communication links.

In some examples, two or more UEs 115 (for example, shown as UE 115i and UE 115j) may communicate directly with one another using sidelink communications (for example, without communicating by way of a network node 105 as an intermediary). As an example, the UE 115i may directly transmit data, control information, or other signaling as a sidelink communication to the UE 115j. This is in contrast to, for example, the UE 115i first transmitting data in a UL communication to a network node 105, which then transmits the data to the UE 115j in a DL communication. In various examples, the UEs 115 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 105 may schedule and/or allocate resources for sidelink communications between UEs 115 in the wireless communication network 100. In some other deployments and configurations, a UE 115 (instead of a network node 105) may perform, or collaborate or negotiate with one or more other UEs to perform, scheduling operations, resource selection operations, and/or other operations for sidelink communications.

In some examples, the UEs 115 and the network nodes 105 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

As an example of operation at the wireless communication network 100, the network nodes 105a-105c serve the UEs 115a and 115b using 3D beamforming and coordinated spatial techniques, such as coordinated multipoint (CoMP) or multi-connectivity. Macro network node 105d performs backhaul communications with the network nodes 105a-105c, as well as with the small cell network node 105f. Macro network node 105d also transmits multicast services which are subscribed to and received by the UEs 115c and 115d. Such multicast services may include mobile television or streaming video, or may include other services for providing community information, such as weather emergencies or alerts, such as Amber alerts or gray alerts.

The wireless communication network 100 of implementations supports mission critical communications with ultra-reliable and redundant links for mission critical devices, such the UE 115e, which is a drone. Redundant communication links with the UE 115e include communication links from the macro network nodes 105d and 105e, as well as the small cell network node 105f. Other machine type devices, such as UE 115f (thermometer), the UE 115g (smart meter), and the UE 115h (wearable device) may communicate through the wireless communication network 100 either directly with network nodes, such as the small cell network node 105f and the macro network node 105e, or in multi-hop configurations by communicating with another user device which relays its information to the network, such as the UE 115f communicating temperature measurement information to the UE 115g, which is then reported to the network through the small cell network node 105f. The wireless communication network 100 may provide additional network efficiency through dynamic, low-latency TDD or FDD communications, such as in a vehicle-to-vehicle (V2V) mesh network between the UEs 115i-115k communicating with the macro network node 105e.

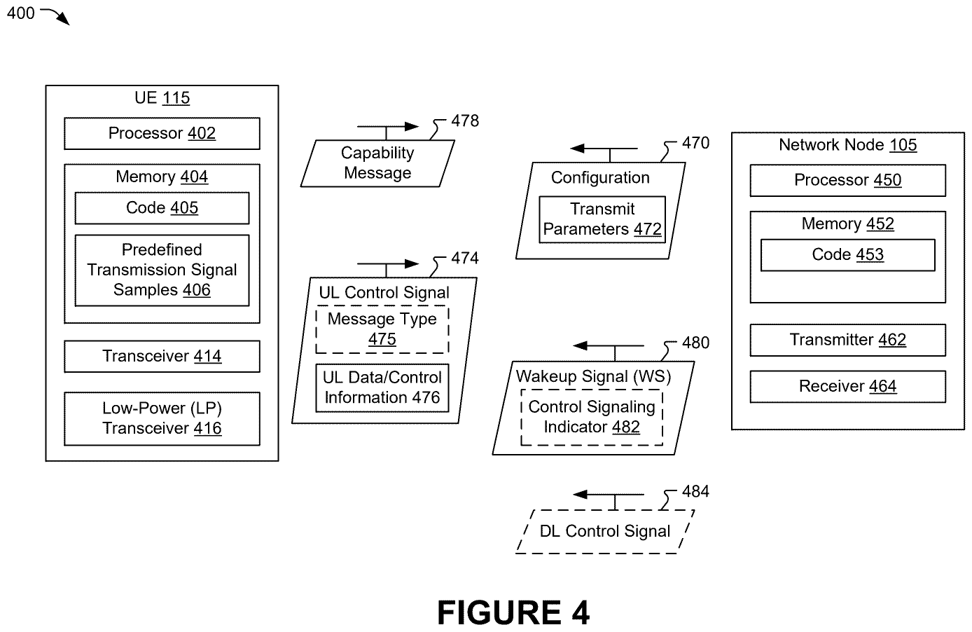

In some aspects, one or more of the network nodes 105 and one or more of the UEs 115 may perform wireless communications that support configuring UL control signaling and UL timing adjustment for a multi-transceiver device. For example, one or more of the UEs 115 (such as the UE 115c) may include a multi-transceiver wakeup manager 150 that manages operations that support UL control signaling or UL timing adjustment by a multi-transceiver device. The operations may include transmitting, via a secondary transceiver, during a WUS monitoring period, a UL transmission signal selected, in accordance with a first parameter value and a second parameter value, from one or more predefined transmission signals, as further described herein with reference to FIG. 4. Additionally, or alternatively, the operations may include receiving, via the secondary transceiver, during a WUS monitoring period, a control signal indicator and, in accordance with the control signal indicator indicating that control signaling is to be communicated, a DL control signal indicating a timing advance command that is used to adjust a transmission time associated with UL transmission signals via the secondary transceiver. As another example, one or more of the network nodes 105 (such as the network node 105d) may include a multi-transceiver wakeup manager 152 that manages operations that support configuration of control signaling or UL timing adjustment by a multi-transceiver device. The operations may include transmitting a configuration indicating multiple parameters associated with a secondary transceiver and a WUS monitoring period and receiving a UL transmission signal that is selected in accordance with a first parameter value and a second parameter value from one or more predefined transmission signals, as further described herein with reference to FIG. 4. Additionally, or alternatively, the operations may include receiving a PRACH preamble during a WUS monitoring period, transmitting a control signaling indicator during the WUS monitoring period, and transmitting, during the WUS monitoring period and in accordance with the control signaling indicator indicating that the control signaling is to be communicated, a DL control signal indicating a timing advance command and an associated timing advance parameter value.

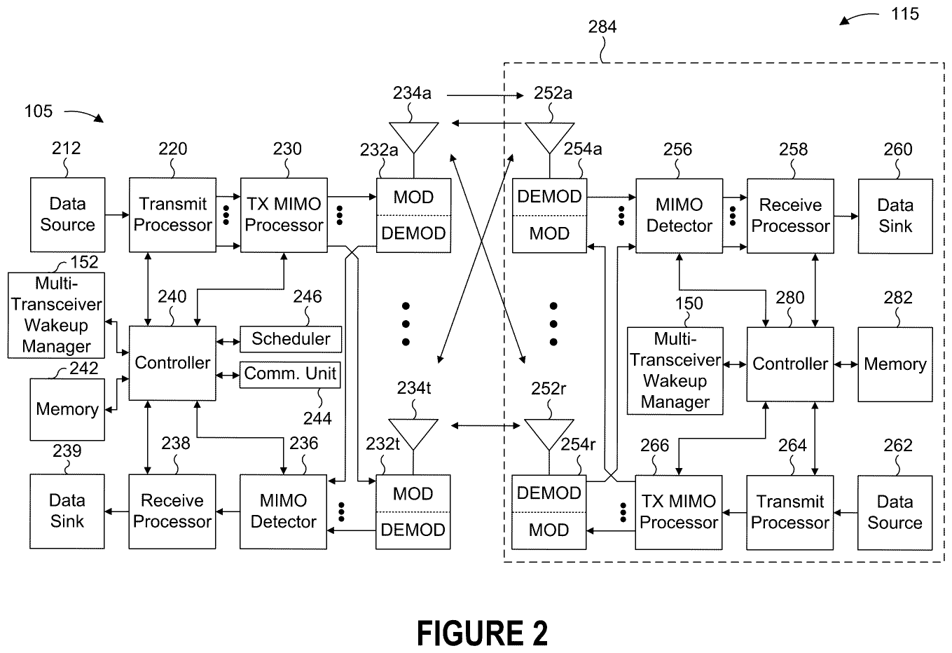

FIG. 2 is a block diagram illustrating examples of a network node 105 and a UE 115 in accordance with the present disclosure. The network node 105 and the UE 115 may be one of the network nodes 105 and one of the UEs 115 in FIG. 1. For a restricted association scenario, the network node 105 may be the small cell network node 105f in FIG. 1, and the UE 115 may be the UE 115c or 115d operating in a service area of the network node 105f, which in order to access the small cell network node 105f, would be included in a list of accessible UEs for the small cell network node 105f. Additionally, the network node 105 may be a base station or network entity of some other type. As shown in FIG. 2, the network node 105 may be equipped with antennas 234a through 234t, and the UE 115 may be equipped with antennas 252a through 252r for facilitating wireless communications.

For downlink communication from the network node 105 to the UE 115, a transmit processor 220 may receive data (“downlink data”) from a data source 212 (such as a data pipeline or a data queue) and control information from a controller 240. The control information may be for the physical broadcast channel (PBCH), physical control format indicator channel (PCFICH), physical hybrid-ARQ (automatic repeat request) indicator channel (PHICH), PDCCH, enhanced physical downlink control channel (EPDCCH), or MTC physical downlink control channel (MPDCCH), among other examples. The data may be for the PDSCH, among other examples. The transmit processor 220 may process, such as encode and symbol map, such as in accordance with a selected modulation and coding scheme (MCS), the data and control information to obtain data symbols and control symbols, respectively. Additionally, the transmit processor 220 may generate reference symbols for reference signals, such as for a cell-specific reference signal (CRS), a demodulation reference signal (DMRS), or a channel state information (CSI) reference signal (CSI-RS) and/or synchronization signals, such as for a primary synchronization signal (PSS) or a secondary synchronization signal (SSS).

Transmit (TX) multiple-input multiple-output (MIMO) processor 230 may perform spatial processing on the data symbols, the control symbols, and/or the reference symbols, if applicable, and may provide output symbol streams to modems 232a through 232t. For example, each output symbol stream may be provided to a respective modulator component (shown as MOD) of a modem 232. In some examples, spatial processing performed on the data symbols, the control symbols, and/or the reference symbols may include precoding. Each modem 232 may use the respective modulator component to process a respective output symbol stream, such as for OFDM, among other examples, to obtain an output sample stream. Each modem 232 may additionally, or alternatively use the respective modulator component to process the output sample stream to obtain a downlink signal. For example, to process the output sample stream, each modem 232 may use the respective modulator component to convert to analog, amplify, filter, and upconvert the output sample stream to obtain the downlink signal. The modems 232a through 232t may together transmit a set of downlink signals from via the antennas 234a through 234t, respectively.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

At the UE 115, the antennas 252a through 252r may receive the downlink signals from the network node 105 and may provide a set of received signals to modems 254a through 254r. For example, each received signal may be provided to a respective demodulator component (shown as DEMOD) of a modem 254. Each modem 254 may use the respective demodulator component to condition a respective received signal to obtain input samples. For example, to condition the respective received signal, the demodulator component of each modem 254 may filter, amplify, downconvert, and/or digitize the respective received signal to obtain the input samples. Each modem 254 may use the respective demodulator component to further process the input samples, such as for OFDM, among other examples, to obtain received symbols. MIMO detector 256 may obtain received symbols from modems 254a through 254r, perform MIMO detection on the received symbols if applicable, and provide detected symbols. Receive processor 258 may process the detected symbols, provide decoded data for the UE 115 to a data sink 260 (which may include a data pipeline, a data queue, and/or an application executed on the UE 115), and provide decoded control information to a controller 280. For example, to process the detected symbols, the receive processor 258 may demodulate, deinterleave, and decode the detected symbols.

In some aspects, one or a combination of the antenna(s) 252, the modem(s) 254, the MIMO detector 256, the receive processor 258, the transmit processor 264, or the TX MIMO processor 266 may be included in a transceiver that is included in the UE 115. The transceiver may be under control of and used by one or more processors, such as the controller 280, and in some aspects in conjunction with processor-readable code stored in the memory 282, to perform aspects of the methods, processes, or operations described herein. In some aspects, the UE 115 may include another interface, another communication component, and/or another component that facilitates communication with the network node 105 and/or another UE 115. Additionally, or alternatively, one or more of the components of the UE 115 may be included in a housing 284.

For uplink communications from the UE 115 to the network node 105, a transmit processor 264 may receive and process data (“uplink data”) from a data source 262 and control information (such as for the PUCCH) from the controller 280. The control information may include one or more parameters, feedback, one or more signal measurements, and/or other types of control information. In some aspects, the receive processor 258 and/or the controller 280 may determine, for a received signal (such as received from the network node 105 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 115 by the network node 105.

The transmit processor 264 may generate reference symbols for a reference signal, such as an uplink DMRS, an uplink sounding reference signal (SRS), and/or another type of reference signal. The symbols from the transmit processor 264 may be precoded by a TX MIMO processor 266, if applicable, and further processed by the modems 254a through 254r (such as for DFT-s-OFDM or CP-OFDM, among other examples). The TX MIMO processor 266 may perform spatial processing (for example, precoding) on the data symbols, the control symbols, and/or the reference symbols, if applicable, and may provide a set of output symbol streams to the modems 254. For example, each output symbol stream may be provided to a respective modulator component (shown as MOD) of a modem 254. Each modem 254 may use the respective modulator component to process a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals via the corresponding antennas 252a through 252r, respectively. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 115) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

At network node 105, the uplink signals from the UE 115 may be received by antennas 234a through 234t, processed by demodulator components of the modems 232a through 232t, detected by a MIMO detector 236 if applicable, and further processed by a receive processor 238 to obtain decoded data and/or control information sent by the UE 115. The receive processor 238 may provide the decoded data to a data sink 239 (which may be a data pipeline, a data queue, and/or another type of data sink) and provide the decoded control information to the controller 240.

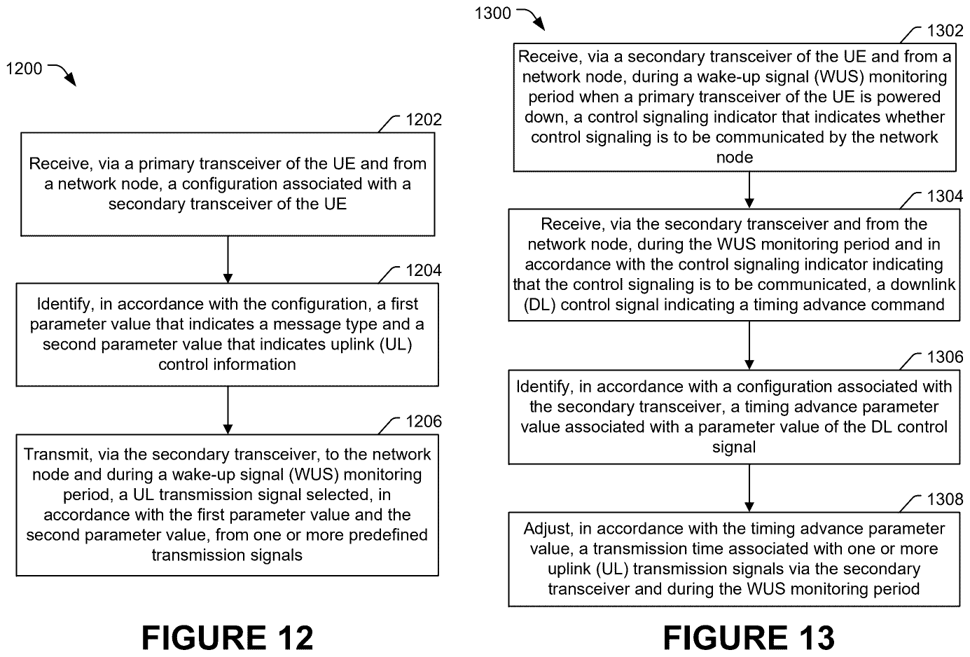

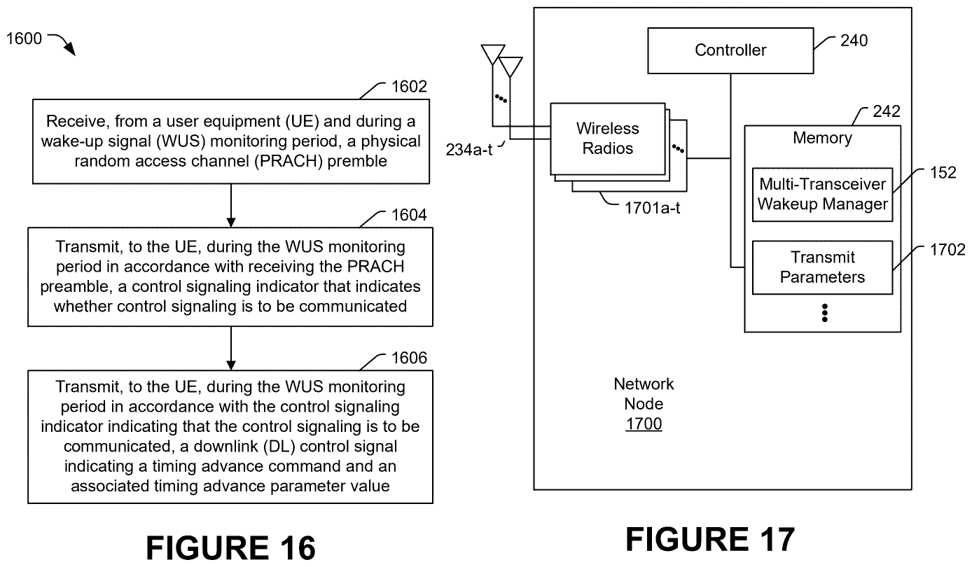

The controllers 240 and 280 may direct the operation at the network node 105 and the UE 115, respectively. The controller 240 (or other processors and modules at the network node 105) may perform or direct the execution of various processes for the techniques described herein, such as to perform or direct the execution illustrated in FIG. 15-16, or other processes for the techniques described herein. Similarly, the controller 280 (or other processors and modules at the UE 115) may perform or direct the execution of various processes for the techniques described herein, such as to perform or direct the execution illustrated in FIGS. 12-13 or other processes for the techniques described herein. For example, the controller 240 and/or the controller 280 may perform or control operations that support configuring UL control signaling and UL timing adjustment of a multi-transceiver device. Additionally, or alternatively, the UE 115 may include the multi-transceiver wakeup manager 150 and the network node 105 may include the multi-transceiver wakeup manager 152 that are configured to manage operations to support configuring UL control signaling and UL timing adjustment of a multi-transceiver device, as further described herein. Although referred to as “controllers”, the controllers 240 and 280 may include one or more processors and/or one or more controllers, and also or in the alternative be referred to as “processors” or “controller/processors”. In some aspects, a single processor may perform all of the operations described as being performed by the one or more processors or the one or more controllers. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors.

The memories 242 and 282 may store data and program codes for the network node 105 and the UE 115, respectively. Reference to “one or more memories” should be understood to refer to any one or more memories of a corresponding device, such as the memory described in connection with FIG. 2. For example, an operation described as being performed by one or more memories can be performed by the same subset of the one or more memories or different subsets of the one or more memories.

The network node 105 may use a scheduler 246 to schedule one or more UEs 115 for downlink or uplink communications. In some aspects, the scheduler 246 may use DCI to dynamically schedule DL transmissions to the UE 115 and/or UL transmissions from the UE 115. In some examples, the scheduler 246 may allocate recurring time domain resources and/or frequency domain resources that the UE 115 may use to transmit and/or receive communications using an RRC configuration (for example, a semi-static configuration), for example, to perform semi-persistent scheduling (SPS) or to configure a configured grant (CG) for the UE 115.

In some examples, the network node 105 may use a communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 105 may use the communication unit 244 to transmit and/or receive data associated with the UE 115 or to perform network control signaling, among other examples. The communication unit 244 may include a transceiver and/or an interface, such as a network interface.

One or more antennas of the antennas 252 or the antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 115 or network nodes 105 may include different numbers of antenna elements. For example, a UE 115 may include a single antenna element, two antenna elements, four antenna elements, eight antenna elements, or a different number of antenna elements. As another example, a network node 105 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

FIG. 3 is a block diagram illustrating an example disaggregated base station architecture 300 in accordance with the present disclosure. One or more components of the example disaggregated base station architecture 300 may be, may include, or may be included in one or more network nodes (such as one or more network nodes 105). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). In some implementations, the core network 320 includes or corresponds to the core network 120 of FIG. 1. The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 115 via respective RF access links. In some deployments, a UE 115 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

The UEs 115, the CU 310, the DUs 330, the RUs 340, or any other component(s) of FIG. 3 may implement one or more techniques or perform one or more operations associated with configuring UL control signaling and UL timing adjustment of a multi-transceiver device, as described further herein. For example, the UEs 115 may include the multi-transceiver wakeup manager 150 and the RUs 340 may include the multi-transceiver wakeup manager 152, which may manage operations to support configuring UL control signaling and UL timing adjustment of a multi-transceiver device. Although shown as being included in a single UE 115 in FIG. 3, any of the UEs 115 may include the multi-transceiver wakeup manager 150, and although shown as being included in a single RU 340 in FIG. 3, any of the RUs 340, the DUs 330, the CU 310, the Non-RT RIC 350, the SMO Framework 360, the Near-RT RIC 370, or a combination thereof, may include the multi-transceiver wakeup manager 152. The multi-transceiver wakeup manager 150 may direct operations of, for example, the process 1200 of FIG. 12, the process 1300 of FIG. 13, or other processes as described herein (alone or in conjunction with one or more other processors). Similarly, the multi-transceiver wakeup manager 152 may direct operations of, for example, the process 1500 of FIG. 15, the process 1600 of FIG. 16, or other processes as described herein (alone or in conjunction with one or more other processors).

In some examples, the multi-transceiver wakeup manager 150 or the multi-transceiver wakeup manager 152 may include, or have access to, a non-transitory computer-readable medium storing a set of instructions (for example, code or program code) for wireless communication. The memory may include one or more memories, such as a single memory or multiple different memories (of the same type or of different types). For example, the set of instructions, when executed (for example, directly, or after compiling, converting, or interpreting) by the multi-transceiver wakeup manager 150 or one or more processors of the UE 115 may cause the one or more processors or the multi-transceiver wakeup manager 150 to perform the process 1200 of FIG. 12, the process 1300 of FIG. 13, or other processes as described herein. As another example, the set of instructions, when executed (for example, directly, or after compiling, converting, or interpreting) by the multi-transceiver wakeup manager 152, one or more processors of the network node 105, the CU 310, the DU 330, the RU 340, the Non-RT RIC 350, the SMO Framework 360, or the Near-RT RIC 370, may cause the one or more processors or the multi-transceiver wakeup manager 152 to perform the process 1500 of FIG. 15, the process 1600 of FIG. 16, or other processes as described herein. In some examples, executing instructions may include running the instructions, converting the instructions, compiling the instructions, and/or interpreting the instructions, among other examples.

FIG. 4 is a block diagram illustrating an example wireless communication system 400 that supports UL control signaling by a multi-transceiver UE in accordance with the present disclosure. In some examples, the wireless communication system 400 may implement aspects of the wireless communication network 100. The wireless communication system 400 includes the UE 115 and the network node 105. Although one UE 115 and one network node 105 are illustrated, in some other implementations, the wireless communication system 400 may generally include multiple UEs 115, multiple network nodes 105, or both.

The UE 115 can include a variety of components (such as structural, hardware components) used for carrying out one or more functions described herein. For example, these components can include one or more processors 402 (hereinafter referred to collectively as “the processor 402”), one or more memory devices 404 (hereinafter referred to collectively as “the memory 404”), one or more transceivers 414 (hereinafter referred to collectively as “the transceiver 414”), and one or more LP transceivers 416 (hereinafter referred to collectively as “the LP transceiver 416”). Although referred to as a processor 402, the UE 115 may include one or more chips, system-on-chips (SoCs), chipsets, packages, or devices that individually or collectively constitute or include a processing system. The processing system includes processor (or “processing”) circuitry in the form of one or multiple processors (such as the processor 402), microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor 402” or “the processor circuitry”).

One or more of the processors 402 may be individually or collectively configurable or configured to perform various functions or operations described herein. A group of processors, such as the processors 402, collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 402 may be configured to execute code 405, such as one or more instructions of processor-readable code, stored in the memory 404 to perform the operations described herein. In some implementations, the processor 402 includes or corresponds to the receive processor 258, the transmit processor 264, the controller 280, or a combination thereof, and the memory 404 includes or corresponds to the memory 282, described with reference to FIG. 2. In some implementations, the processor 402, the memory 404, the code 405, another component of the UE 115, or a combination thereof, may include or correspond to the multi-transceiver wakeup manager 150 of FIGS. 1-3 and/or may perform the operations associated with the multi-transceiver wakeup manager 150 to support UL control signaling and/or UL timing adjustment by a multi-transceiver UE. In some implementations, a “processing system” includes one or more processors (the processor 402) and one or more memories (the memory 404) that store the code 405 and are coupled with one or more processors. In such embodiments, such a processing system is configured to cause the UE 115 to perform the operations described herein.

The memory 404 may be configured to store the code 405 and predefined transmission signal samples 406. The predefined transmission signal samples 406 may include samples of signals that are generated by the UE 115 and stored in the memory 404 for use in generating UL transmission signals to be transmitted during a wakeup signal (WUS) monitoring period as UL control signaling, as further described herein. Although shown in FIG. 4 as a single memory 404, in some implementations, the memory 404 may include at least two memories, such as a “main memory” associated with the transceiver 414 and an “LP transceiver memory” associated with the LP transceiver 416.

The transceiver 414 is configured to transmit reference signals, control information and data to one or more other devices, and to receive reference signals, synchronization signals, control information and data from one or more other devices. For example, the transceiver 414 may transmit signaling, control information and data to, and receive signaling, control information and data from, the network node 105. In some implementations, the transceiver 414 includes, or has integrated within, a transmitter and a receiver. Additionally, or alternatively, the transceiver 414 may include or correspond to one or more components of the UE 115 described with reference to FIG. 2. The transceiver 414 may be referred to as a main transceiver or a primary transceiver, and the transceiver 414 may be configured to transmit or receive signaling, control information, and data during a normal operating mode or active operating mode associated with the UE 115.

The LP transceiver 416 is configured to transmit a limited subset of signaling to one or more other devices, and to receive a limited subset of signaling from one or more other devices. For example, the LP transceiver 416 may transmit the limited subset of signaling to, and receive the limited subset of signaling from, the network node 105. In some implementations, the LP transceiver 416 includes, or has integrated within, an LP transmitter and an LP receiver. Additionally, or alternatively, the LP transceiver 416 may include or correspond to one or more components of the UE 115 described with reference to FIG. 2. The LP transceiver 416 may be referred to as a “low-power” transceiver or a secondary transceiver, because power consumed by the LP transceiver 416 to send or receive signaling is less than power consumed by the transceiver 414 to send or receive signaling. It is noted that the “low-power” aspect of the LP transceiver 416 refers to the power consumption of the LP transceiver 416 to send or receiving signaling and not to the signal strength or signal power of the signals that are sent or received. The LP transceiver 416 may be configured to transmit or receive during an LP operating mode or a sleep mode associated with the UE 115. In some implementations, the LP transceiver 416 is capable of being activated and deactivated quickly, as compared to the transceiver 414, and the LP transceiver 416 is capable of receiving, generating, and processing “simple” signals of the limited subset of signaling, such as signals within limited bandwidths and having simpler waveforms, as compared to the signaling of the transceiver 414.

In some implementations, the LP transceiver 416 is configured to communicate using on-off keying (OOK) waveforms, such as OOK-1 waveforms or OOK-4 waveforms, as non-limiting examples. In suck OOK waveforms, a particular duration of high signal power (or low signal power) can represent an information bit. In some such implementations, the durations of high signal power may be overlaid with an orthogonal frequency division multiplexing (OFDM) sequence to convey additional information. The OFDM sequence may include a Gold sequence, a maximum length sequence (m-sequence), a computer searched sequence, a Zadoff-Chu (ZC) sequence, or a Golay sequence, as illustrative, non-limiting examples. Such sequences can be capable of being decoded without frequency demodulation at a receiving device, such as by detection of a cyclic shift or another characteristic, which can be used to represent information such as a parameter value, as further described herein.

The network node 105 can include a variety of components (such as structural, hardware components) used for carrying out one or more functions described herein. For example, these components can include one or more processors 450 (hereinafter referred to collectively as “the processor 450”), one or more memory devices 452 (hereinafter referred to collectively as “the memory 452”), one or more transmitters 462 (hereinafter referred to collectively as “the transmitter 462”), and one or more receivers 464 (hereinafter referred to collectively as “the receiver 464”). Although referred to as a processor 450, the network node 105 may include one or more chips, SoCs, chipsets, packages, or devices that individually or collectively constitute or include a processing system. The processing system includes processor (or “processing”) circuitry in the form of one or multiple processors (such as the processor 450), microprocessors, processing units (such as CPUs, GPUs, NPUs and/or DSPs), processing blocks, ASICs, PLDs (such as FPGAs), or other discrete gate or transistor logic or circuitry (all of which may be generally referred to herein individually as “processors” or collectively as “the processor 450” or “the processor circuitry”).

One or more of the processors 450 may be individually or collectively configurable or configured to perform various functions or operations described herein. A group of processors, such as the processors 450, collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 450 may be configured to execute code 453, such as one or more instructions, stored in the memory 452 to perform the operations described herein. In some implementations, the processor 450 includes or corresponds to the receive processor 238, the transmit processor 220, the controller 240, or a combination thereof, and the memory 452 includes or corresponds to the memory 242, described with reference to FIG. 2. In some implementations, the processor 450, the memory 452, the code 453, another component of the network node 105, or a combination thereof, may include or correspond to the multi-transceiver wakeup manager 152 of FIGS. 1-3 and/or may perform the operations associated with the multi-transceiver wakeup manager 152 to support configuring UL control signaling and/or UL timing adjustment for a multi-transceiver UE. In some implementations, a “processing system” includes one or more processors (the processor 450) and one or more memories (the memory 452) that store the code 453 and are coupled with one or more processors. In such embodiments, such a processing system is configured to cause the network node 105 to perform the operations described herein.

The memory 452 may be configured to store the code 453 and, optionally, additional data to support the operations described herein. The transmitter 462 is configured to transmit reference signals, synchronization signals, control information, and data to one or more other devices, and the receiver 464 is configured to receive reference signals, control information and data from one or more other devices. For example, the transmitter 462 may transmit signaling, control information and data to, and the receiver 464 may receive signaling, control information and data from, the UE 115. In some implementations, the transmitter 462 and the receiver 464 may be integrated in one or more transceivers. Additionally, or alternatively, the transmitter 462 or the receiver 464 may include or correspond to one or more components of network node 105 described with reference to FIG. 2.

In some implementations, the wireless communication system 400 is configured to implement a 5G NR network or a 6G network. For example, the wireless communication system 400 may include multiple 5G-capable UEs 115 (or 6G-capable UEs 115) and multiple 5G-capable network nodes 105 (or 6G-capable network nodes 105), such as UEs and network nodes configured to operate in accordance with a 5G NR network protocol, or a 6G network protocol, such as that defined by the 3GPP. In some examples, the wireless communication system 400 includes multiple multi-transceiver UEs 115.

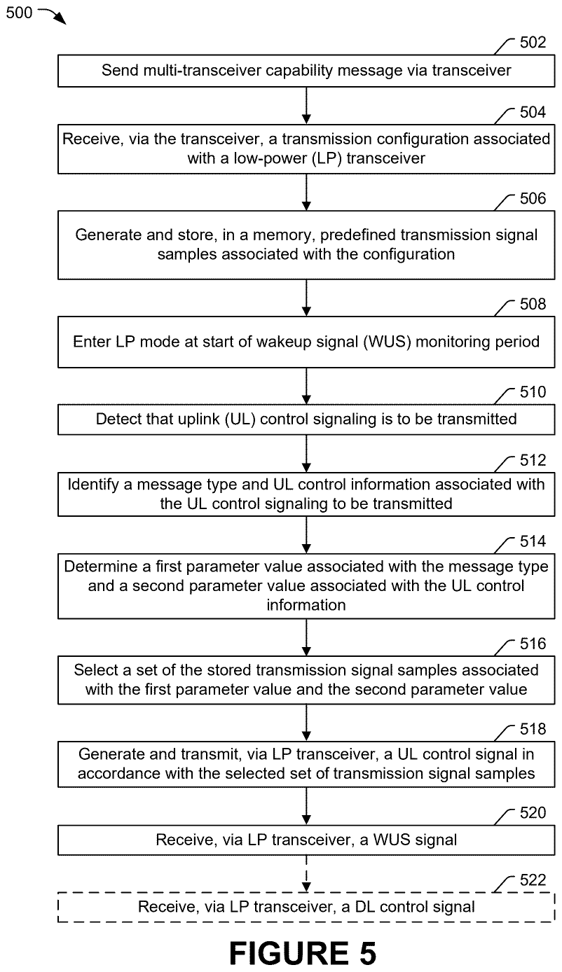

During operation of the wireless communication system 400, the UE 115 and the network node 105 may perform one or more operations shown in FIG. 5, which is a flow diagram illustrating an example of a process 500 that supports UL control signaling by the multi-transceiver UE 115 of FIG. 4 in accordance with the present disclosure. The UE 115 begins the process 500 in a normal operating mode, also referred to as an active operating mode, in which the transceiver 414 is active and the LP transceiver 416 is in a powered down mode or sleep mode, also referred to as deactivated. For example, the UE 115 may enter the normal operating mode when the UE 115 is powered on, upon a command from an application being executed at the UE 115, or after receiving a WUS from the network node 105, as non-limiting examples, and to enter the normal operating mode, the UE 115 may activate the transceiver 414 and deactivate the LP transceiver 416.

While operating in the normal operating mode, the UE 115 may perform wireless communications via the transceiver 414, and the LP transceiver 416 remains deactivated or turned off. The transceiver 414 is capable of transmitting and receiving a wider variety of signaling than the LP transceiver 416, and thus the UE 115 may operate in the normal operating mode during time periods when there is a significant amount of data to be transmitted or received, when the UE 115 is performing wireless communications associated with higher throughput or signal quality criteria, or during other time periods. Because a power consumption rate associated with the normal operating mode (an “active mode”) is greater than a power consumption rate associated with an LP mode (a “powered-down mode”), the UE 115 may be configured to enter the LP mode at times to conserve power, as further described below.

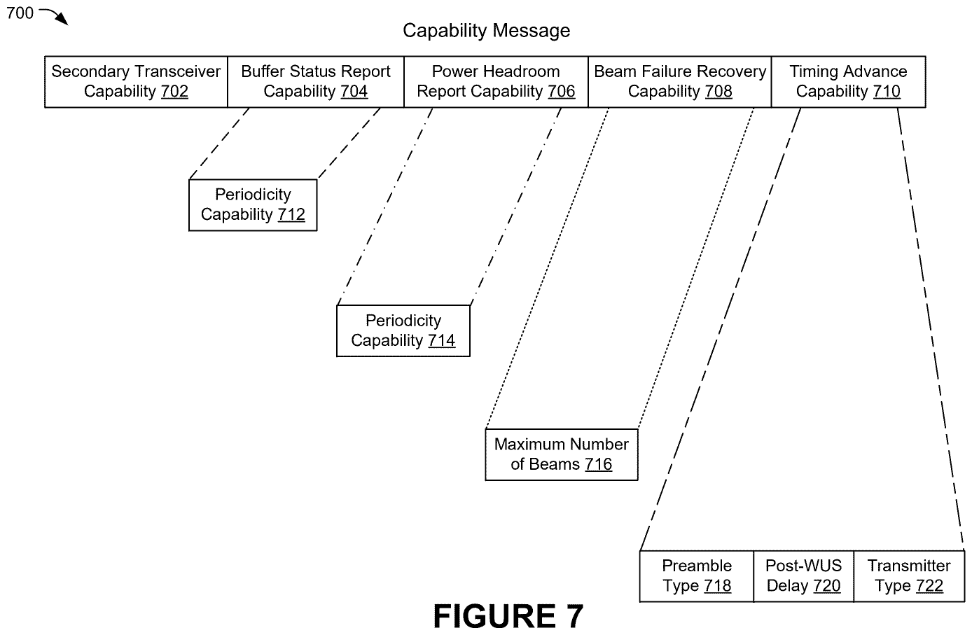

At 502, the UE 115 sends, via the transceiver 414, a capability message 478 to the network node 105. In some implementations, the UE 115 sends the capability message 478 as radio resource control (RRC) signaling. The capability message 478, which may be referred to as a multi-transceiver capability message, indicates various types of UL control signaling and related parameters that are capable of being transmitted by the UE 115 using the LP transceiver 416. As non-limiting examples, the capability message 478 may indicate a buffer status report capability associated with the LP transceiver 416, a power headroom report capability associated with the LP transceiver 416, a beam failure recovery capability associated with the LP transceiver 416, a timing advance capability associated with the LP transceiver 416, or a combination thereof. An example of such a capability message is further described herein, with reference to FIG. 7.

At 504, the network node 105 sends a configuration 470 to the UE 115. For example, the network node 105 may generate the configuration 470 for the UE 115 in accordance with the capability message 478. In some implementations, the network node 105 sends the configuration 470 as RRC signaling. The UE 115 receives the configuration 470 via the transceiver 414. The configuration 470, which is associated with the LP transceiver 416, indicates various UL control signaling configurations to be sent by the UE 115 during a WUS monitoring period. Stated another way, the network node 105 may configure various types of UL control signaling to be performed by the UE 115 by sending the configuration 470 to the UE 115. In some implementations, the configuration 470 may also indicate one or more UL control signaling configurations to be sent by the UE 115 using the transceiver 414 during operation in the normal operating mode. In such implementations, the configuration 470 may be referred to as a multi-transceiver transmission configuration.

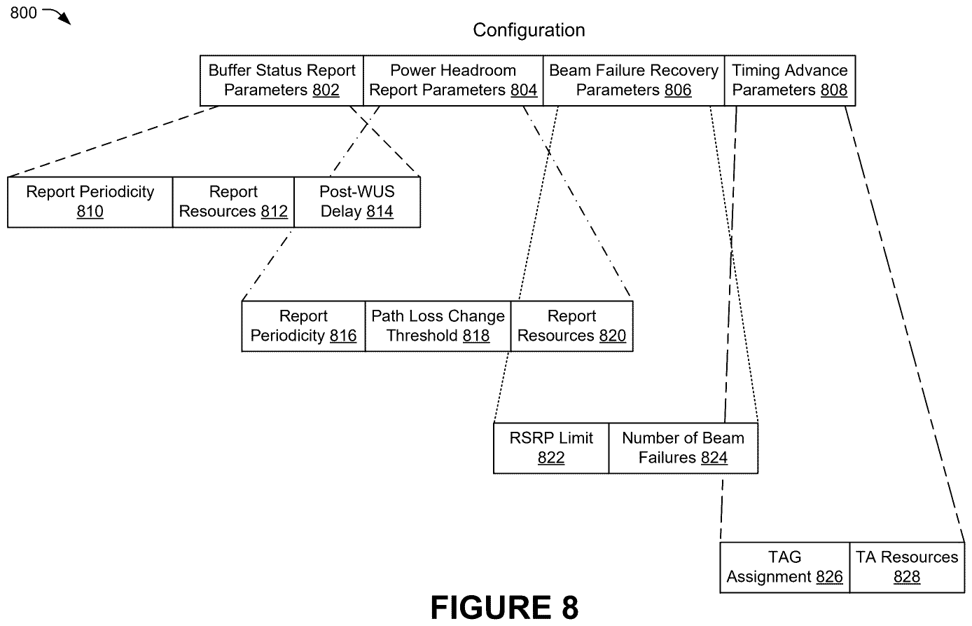

To configure UL control signaling that is to be sent using the LP transceiver 416, the configuration 470 includes one or more transmit parameters 472 (hereinafter referred to collectively as “the transmit parameters 472”). The transmit parameters 472 may be used to generate UL control signaling to be sent by the UE 115 during a WUS monitoring period when the UE 115 is to be operating in the LP mode with the transceiver 414 deactivated. As non-limiting examples, the transmit parameters 472 may include parameters associated with a buffer status report, a power headroom report, a beam failure recovery message, a timing advance command, or a combination thereof. An example of such a configuration is further described herein, with reference to FIG. 8. The WUS monitoring period may be a duration of time during which the UE 115 is permitted to operate in the LP mode unless a WUS with an instruction to transition to the active mode is received from the network node 105. In some implementations, a duration of the WUS monitoring period, criteria for entering the WUS monitoring period, and/or other rules or parameters associated with the WUS monitoring period may be stored at the UE 115 and the network node 105, and in some implementations, may be defined in one or more wireless communication standards.

At 506, the UE 115 generates and stores, in the memory 404, the predefined transmission signal samples 406. The predefined transmission signal samples 406 are “simpler” signals that are capable of being transmitted by the LP transceiver 416, which has a power consumption rate less than the transceiver 414. For example, the predefined transmission signal samples 406 may include samples of OOK waveforms, samples of OOK waveforms with overlaid OFDM sequences, or samples of other types of waveforms or signals that are capable of being decoded without frequency demodulation at a receiver.

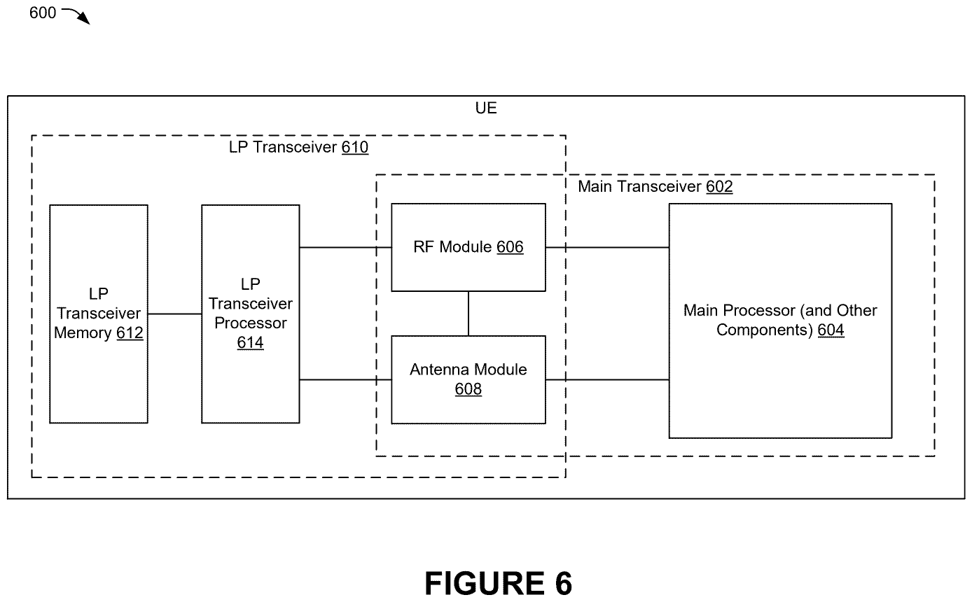

In some implementations, the predefined transmission signal samples 406 include samples of various types of signals, such as OOK signals, OOK signals overlaid with orthogonal frequency division multiplexing sequences, or other types of signals that are capable of being decoded without being frequency demodulated, and as such, the parameters may include index values of mathematical sequences used to generate the predefined transmission signals, cyclic shifts applied to the mathematical sequences, or sets of subcarriers via which the predefined transmission signals are transmitted (also referred to as “active subcarriers”). Additionally, or alternatively, each of the predetermined transmission signals may be generated and sampled while the UE 105 is operating in the normal operating mode and using the transceiver 414. Such predefined transmission signal samples may be stored in a portion of the memory 404 or a distinct LP transceiver memory (as described with reference to FIG. 6) that is accessible to the LP transceiver 416 while the UE 105 is in the LP mode. By preprocessing and sampling predefined transmission signals while the UE 105 is in the normal operating mode and storing the predefined transmission signal samples 406 in the memory 404, the LP transceiver 416 is enabled to generate UL transmission signals using the predefined transmission signal samples 406, which consumes less power than processing and generating the signals in real-time during operation in the LP mode using the transceiver 414.

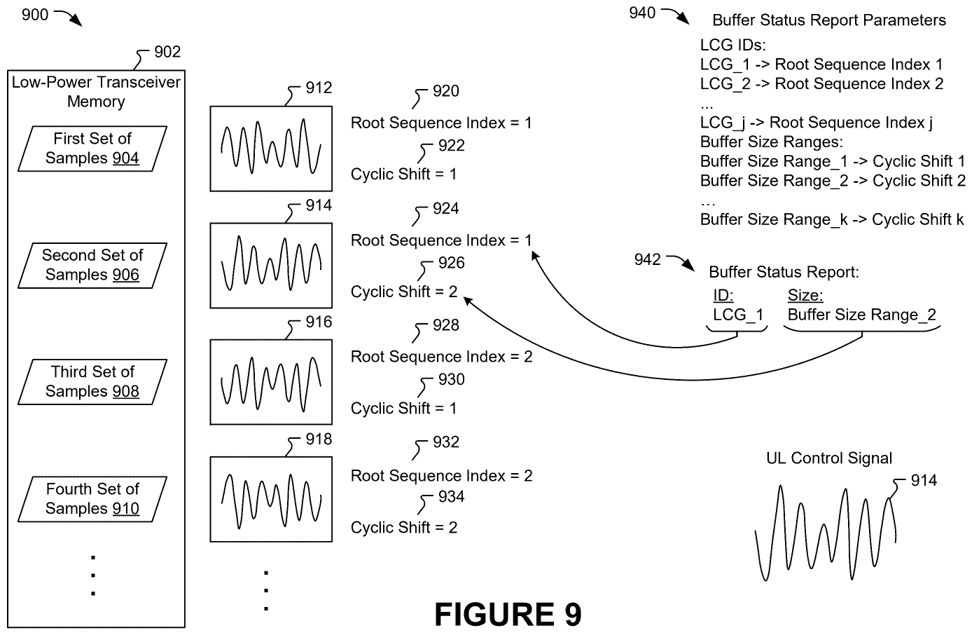

As an illustrative example, the predefined transmission signal samples 406 are associated with the configuration 470, such that the predefined transmission signal samples 406 are collected from signals that are generated by the transceiver 414 and that correspond to one or more of the UL control signaling types that are configured by the configuration 470. For example, if the transmit parameters 472 include one or more buffer sizes, the predefined transmission signal samples 406 may include samples of one or more UL control signals that, when decoded, indicate one or more buffer sizes in accordance with a relationship between signal parameters and buffer sizes indicated by the transmit parameters 472. In this example, different buffer sizes may be indicated by two transmission signals that each are generated in accordance with the same ZC sequence and that each have different cyclic shifts. As another example, if the transmit parameters 472 include one or more power headroom ranges, the predefined transmission signal samples 406 may include samples of one or more UL control signals that, when decoded, indicate one or more power headroom ranges in accordance with a relationship between signal parameters and power headroom ranges indicated by the transmit parameters 472. Additionally, or alternatively, one or more DL signals received by the UE 115 may be selected from the same predefined transmission signals such that, if the transmit parameters 472 include one or more timing advance parameters, the predefined transmission signal samples 406 may include samples of one or more DL signals that, when decoded, indicate one or more timing advance parameter values in accordance with a relationship between signal parameters and timing advance parameter values indicated by the transmit parameters 472. Additional details and examples of predefined transmit signal samples, and the relationship between associated parameter values and message type, UL control information, or other UL control signal parameters, is described further herein with reference to FIG. 9.

At 508, the UE 115 deactivates the transceiver 414 and activates the LP transceiver 416 to enter into the LP operating mode at the start of a WUS monitoring period. Although operating in the normal operating mode enables the UE 115 to perform higher quality or more complicated wireless communications, operating in the normal operating mode consumes more power than operating in the LP operating mode. Thus, to reduce power consumption, the UE 115 may enter the LP operating mode at various times, such as when there is not a significant amount of data to be transmitted or expected to be received, when wireless communications by the UE 115 are not subject to signal quality or throughput criteria, or when instructed by the network node 105, as non-limiting examples.

At 510, the UE 115 detects that UL control signaling is to be transmitted to the network node 105. For example, if a type of UL control signaling is associated with periodic transmissions in accordance with the transmit parameters 472, the UE 115 may detect that UL control signaling is to be transmitted according to an associated periodicity. As another example, the UE 115 may detect that UL control signaling is to be transmitted in accordance with receiving an explicit indication or request from the network node 105. In this example, a WUS or other similar signal that is capable of being decoded without performing frequency demodulation and that has an explicit or implicit indication of request for UL signaling may be transmitted by the network node 105, and upon receipt and decoding of the WUS, the UE 115 may determine to transmit UL control signaling. As another example, an application that is being executed by the UE 115 may provide an instruction or indication that UL control signaling is to be transmitted to the network node 105.

At 512, the UE 115 identifies a message type 475 and UL data/control information 476 associated with the UL control signaling to be transmitted. The message type 475 refers to the type of UL control signaling or messaging to be transmitted by the UE 115. For example, the message type 475 may be a buffer status report, a power headroom report, a beam failure recovery message, or another type of message that indicates UL control signaling and is typically sent as a MAC-CE during operation in the normal operating mode. Additionally, or alternatively, the message type 475 may be a PRACH preamble that is used to trigger a timing advance command from the network node 105. The UL data/control information 476 corresponds to UL control information that would be reported using the MAC-CE but is instead indicated by UL control signaling having the message type 475 that is to be sent via the LP transceiver 416. For example, the UL data/control information 476 may indicate an amount of UL data that is buffered for transmission to the network node 105 if the message type 475 is a buffer status report. As another example, the UL data/control information 476 may indicate a power headroom value or range if the message type 475 is a power headroom report. As another example, the UL data/control information 476 may indicate a beam that is associated with a detected beam failure if the message type 475 is a beam failure recovery message. As another example, the UL data/control information 476 may include a PRACH preamble. Some other message types may not include UL data or control information, and in such implementations, the UE 115 does not identify the UL data/control information 476.

At 514, the UE 115 determines a first parameter value associated with the message type 475 and a second parameter value associated with the UL data/control information 476. The first parameter value and the second parameter value are associated with the predefined transmission signals that were sampled by the UE 115 and stored as the predefined transmission signal samples 406. For example, if the predefined transmission signals are generated in accordance with a mathematical sequence, the first parameter may include an index value of the mathematical sequence, and the second parameter may include a cyclic shift applied to the mathematical sequence. In some such examples, the mathematical sequence is a ZC sequence, and the index value is a root sequence index of the ZC sequence. In some other such examples, the mathematical sequence is an m-sequence, and the index value is a primitive polynomial of the m-sequence. Alternatively, if the predefined transmission signals are transmitted via multiple subcarriers, the first parameter value indicates at least one first subcarrier of a first set of subcarriers, and the second parameter value indicates at least one second subcarrier of a second set of subcarriers.

Values of the first parameter may be mapped to various message types, or other signal parameters, by the configuration 470. For example, if the predefined transmission signals are generated in accordance with a ZC sequence, the configuration 470 may indicate associations between root sequence index values and message types of UL control signaling. As an illustrative example, the configuration 470 may indicate that a first root sequence index value is associated with or indicates a buffer status report, a second root sequence index value is associated with or indicates a power headroom report, a third root sequence index value is associated with or indicates a beam failure recovery message, and a fourth root sequence index value is associated with or indicates a PRACH preamble, as non-limiting examples. Alternatively, if the UL control signaling is triggered by the network node 105 such that the message type does not need to be indicated by the UL control signaling, the first parameter values may be associated or mapped with a different parameter of the UL control signaling, such as a logical channel group (LCG) identifier (ID), a UE ID, or a timing advance group (TAG) ID, depending on the type of UL control signaling to be sent by the UE 115.

Additionally, values of the second parameter may be mapped to various UL data or control information, or other signal parameters, by the configuration 470. For example, if the predefined transmission signals are generated in accordance with a ZC sequence and the message type is a buffer status report, the configuration 470 may indicate associations between cyclic shift values and buffer sizes. As an illustrative example, the configuration 470 may indicate that a cyclic shift value is associated with or indicates a first buffer size or range of sizes, a second cyclic shift value is associated with or indicates a second buffer size or range of sizes, a third cyclic shift value is associated with or indicates a third buffer size or range of sizes, and a fourth cyclic shift value is associated with or indicates a fourth buffer size or range of sizes. Similar associations may be provided between message types and primitive polynomial values or first sets of subcarriers, and between UL control information and cyclic shift values or second sets of subcarriers, by the configuration 470. Additional examples of determining parameter values in accordance with message parameters and/or UL control information are described further herein with reference to FIG. 9. In some implementations, DL control information can be similarly indicated by a parameter of a signal that is decodable by the LP transceiver 416, such as by cyclic shift values being associated with timing advance parameter values, similar to buffer sizes or power headroom values.

In a particular example, the UE 115 may determine that a buffer status report is to be transmitted and, based on UL data stored in a buffer at the UE 115, that a buffer size is currently 1.3 kilobytes (KB). In this example, the configuration 470 indicates that a first root sequence index value of a group of root sequence index values is associated with buffer status reports and a second cyclic shift value of a group of cyclic shift values is associated with buffer sizes between 1 KB and 2 KB. Accordingly, the UE 115 may determine that a predefined transmission signal associated with a root index value equal to the first root index value and a cyclic shift equal to the second cyclic shift value represents a buffer status report that indicates a buffer size that is between 1 KB and 2 KB. Alternatively, if the message type 475 is not indicated by UL control signaling, the first root sequence index value may be associated with a LCG ID associated with a LCG that includes the UE 115.

At 516, the UE 115 selects a set of the predefined transmission signal samples 406 associated with the first parameter value and the second parameter value. In the above-described example, the UE 115 may access the memory 404 to identify and select a set of predefined transmission signal samples, from the predefined transmission signal samples 406, that is associated with the first root index value (the first parameter value) and the second cyclic shift value (the second parameter value). Additional details of selecting sets of the predefined transmission signal samples 406 in accordance with determined parameter values are described further herein with reference to FIG. 9.

At 518, the UE 115 generates a UL control signal 474, and transmits the UL control signal 474 to the network node 105 via the LP transceiver 416, in accordance with the selected set of the predefined transmission signal samples 406. For example, the UE 115 may use the LP transceiver 416 to generate and transmit a UL signal that is based on the selected set of predefined transmission signals. Generating the UL control signal 474 using a set of samples and the LP transceiver 416 may use less power than generating a UL control signal using the transceiver 414 and without using stored samples. Thus, transmitting the UL control signal 474 via the LP transceiver 416 may reduce power consumption at the UE 115 while still communicating the information indicated by the UL control signal 474 to the network node 105, as compared to generating and transmitting a UL control signal using the transceiver 414 after transitioning from the LP mode to the normal operating mode.

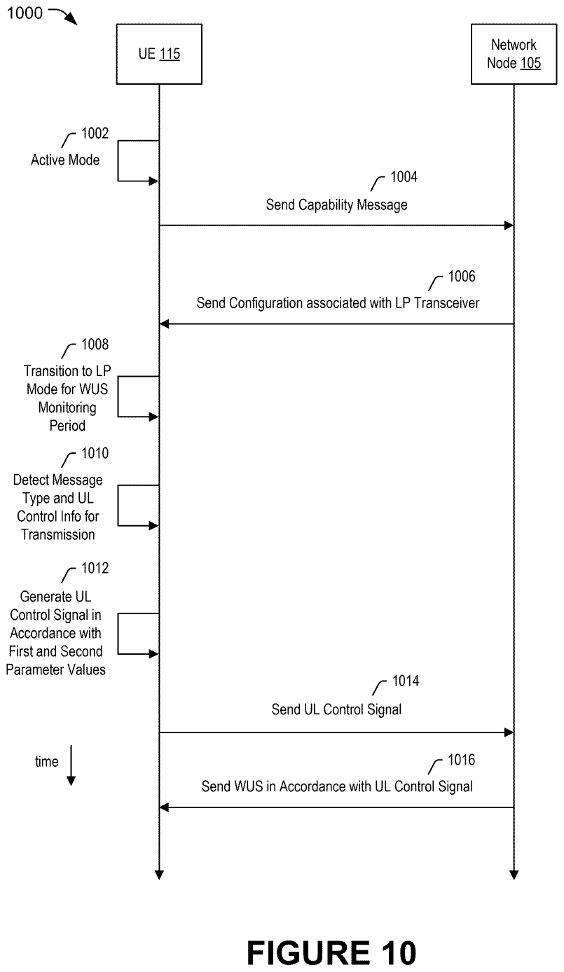

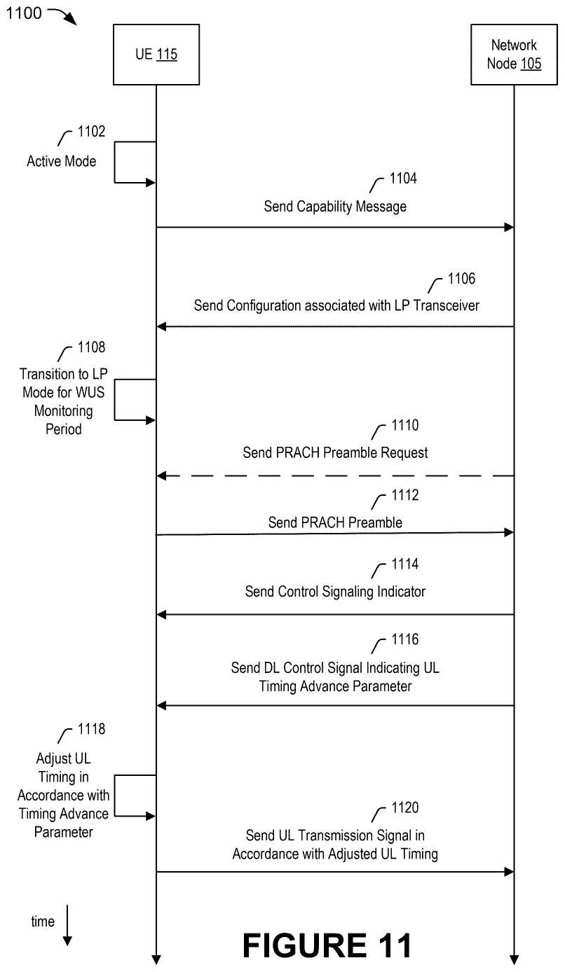

In some examples, the UL control signal 474 indicates a buffer status report, and the UL data/control information 476 indicates a buffer size, which the network node 105 may use in determining to grant UL resources to the UE 115. As another example, the UL control signal 474 indicates a power headroom report, and the UL data/control information 476 indicates a power headroom determined by the UE 115. As another example, the UL control signal 474 indicates a beam failure recovery message, and the UL data/control information 476 indicates a beam associated with a detected beam failure at the UE 115. An example of transmitting UL control signaling indicating such UL control information using an LP transceiver is further described herein, with reference to FIG. 10. In some other examples, the UL control signal 474 and the UL data/control information 476 include or correspond to a PRACH preamble that causes the network node 105 to provide a timing advance command to the UE 115 to enable UL timing adjustment. An example of UL timing adjustment by receiving a timing advance command via an LP transceiver is further described herein, with reference to FIG. 11.

At 520, the network node 105 transmits a WUS 480 to the UE 115 during the WUS monitoring period. In some examples, the network node 105 may determine DL control information provide to the UE 115 in accordance with the UL control signal 474, and the network node 105 may transmit the WUS 480 to indicate the DL control information. For example, if the UL control signal 474 is a buffer status report, the DL control information may include a wakeup instruction to cause the UE 115 to transition from the LP mode to the normal operating mode and monitor for a UL resource grant that is determined by the network node 105 in accordance with the buffer status report. As another example, if the UL control signal 474 is a power headroom report, the DL control information may include a UL transmit power parameter value that is determined by the network node 105 in accordance with the power headroom report. As another example, if the UL control signal 474 is a PRACH preamble, the DL control information may include a timing advance parameter value to that is determined by the network node 105 in accordance with the PRACH preamble.

The UE 115 may receive the WUS 480 via the LP transceiver 416 during the WUS monitoring period. In some implementations, the WUS 480 is a DL control signal that indicates one or more updated values of the transmit parameters 472, an instruction to send an UL transmission signal or control signal, an instruction to enter the active mode (the normal operating mode), other DL control information that would typically be received in a MAC-CE using the transceiver 414, or a combination thereof. In examples in which the WUS 480 indicates an instruction to “wake up” and enter the active mode, the UE 115 activates the transceiver 414 and deactivates the LP transceiver 416, responsive to receiving the WUS 480. There may be a “ramp up” time between activating the transceiver 414 and the transceiver 414 being fully powered on and capable of transmitting or receiving wireless signals, during which the network node 105 may refrain from sending one or more wireless signals or data addressed to the UE 115.

In some implementations, the WUS 480 includes a control signaling indicator 482 that indicates whether control signaling is to be communicated by the network node 105 (in addition to any control signaling in the WUS 480). For example, the control signaling indicator 482 may indicate whether the network node 105 is going to transmit additional DL control signaling following the WUS 480 that is to be interpreted with any DL control signaling included in the WUS 480. As such, the combination of the WUS 480 and a subsequent DL control signal may act as a variable length DL control signal from the perspective of the UE 115. In some implementations, the control signaling indicator 482 is received by the UE 115 in accordance with transmission of the PRACH preamble as the UL control signal 474. For example, in response to receiving the UL control signal 474 that indicates a PRACH preamble, the network node 105 may determine a timing advance command and an associated timing advance parameter value, which may not fit in the WUS 480, and as such, the network node 105 may include the control signaling indicator 482 in the WUS 480 to indicate that addition DL control information will follow transmission of the WUS 480.

In some implementations, the control signaling indicator 482 includes a control bit of a message (the WUS 480) received via the LP transceiver 416 during the WUS monitoring period. In some other implementations, the control signaling indicator 482 includes an implicit indication, such as an indication that corresponds to a parameter of the WUS 480, such as an OFDM sequence that is overlaid on the WUS 480. For example, a first OFDM sequence being overlaid on the WUS 480 may correspond to the control signaling indicator 482 indicating that control signaling is to be communicated in addition to the WUS 480, and a second OFDM sequence being overlaid on the WUS 480 may correspond to the control signaling indicator 482 indicating that control signaling is not to be communicated in addition to the WUS 480. In some implementations, the WUS 480 also includes a wake-up indicator, such as a bit or an implicit indicator, that indicates whether the UE 115 is to transition from the LP mode to the normal operating mode in response to receipt of the WUS 480. For example, a first value (a “1” value) of the wake-up indicator may indicate that the UE 115 is to “wake up” and transition to the normal operating mode, and a second value (e.g., a “0” value) of the wake-up indicator may indicate that the UE 115 is to remain in the LP mode (at least for the duration of the WUS monitoring period or until another WUS is received).

In examples in which the control signaling indicator 482 indicates that control signaling is to be communicated by the network node 105 in addition to any control signaling in the WUS 480, at 522, the network node 105 transmits a DL control signal 484 to the UE 115. The UE 115 may receive the DL control signal 484 via the LP transceiver 416 during the WUS monitoring period, such as subsequent to receipt of the WUS 480, in accordance with the control signaling indicator 482 indicating that control signaling is to be communicated. The DL control signal 484 may indicate DL control information to be used by the UE 115 and that is generated by the network node 105 in accordance with the UL data/control information 476 indicated by the UL control signal 474. For example, the DL control signal 484 may include or correspond to, or contain DL control information that indicates or corresponds to, a communication beam activation (or deactivation), a reference signal (RS) activation or deactivation (such as for a sounding reference signal (SRS) or a channel state information (CSI) reference signal (CSI-RS)), a secondary cell (SCell) activation (or deactivation), a timing advance command, a discontinuous reception (DRX) command, or another type of control information that is typically included in a MAC-CE. In some implementations, the UE 115 may determine the DL control information (or parameters associated with the DL control information) in accordance with the transmit parameters 472 and one or more parameters of the DL control signal 484, similar to as described above for selecting the set of the predefined transmission signal samples 406 in accordance with the first parameter value and the second parameter value described above.

In some implementations, the WUS 480 indicates a timing advance command to the UE 115 and the DL control signal 484 indicates a timing advance parameter value associated with the timing advance command. The DL control signal 484 may also identify a target UE for the timing advance command, or in other examples, the UE 115 may be configured to apply the timing advance parameter value in accordance with having transmitted the PRACH preamble as the UL control signal 474. The DL control signal 484 may be an OOK-based signal, a time domain sequence-based signal, or a frequency index modulation-based signal, depending on the capability of the LP transceiver 416. In some implementations, time and/or frequency resources used to communicate the DL control signal 484 are configured for the UE 115 by the network node 105. Alternatively, the time and/or frequency resources may be resources that are associated with the WUS 480. Additionally, or alternatively, the time and/or frequency resources allocated to the DL control signal 484 may be specified in a wireless communication standard, such as a 3GPP standard.

The UE 115 may receive the DL control signal 484 via the LP transceiver 416 and identify the timing advance parameter value indicated by the DL control signal 484. For example, the UE 115 may identify one or more parameter values associated with the DL control signal 484, such as the presence of a particular OFDM sequence overlaid on the DL control signal 484, a cyclic shift associated with the DL control signal 484, a mathematical sequence index used to generate the DL control signal 484, a set of subcarriers via which the DL control signal 484 is received (also referred to as “active subcarriers” or subcarriers that are “activated” by the DL control signal 484), as non-limiting examples. The UE 115 may determine the timing advance value in accordance with the one or more identified parameter values and the transmit parameters 472, which may map or associate parameter values of control signals with timing advance parameter values, similar to as described above for mathematical index values, cyclic shift values, and sets of subcarriers. For example, the transmit parameters 472 may indicate that first OFDM sequence is associated with a timing advance parameter value of 0.1 ms and that a second OFDM sequence is associated with a timing advance parameter value of 0.2 ms, and based on identification of the second OFDM sequence being overlaid on the DL control signal 484, the UE 115 may determine that the DL control signal 484 indicates a timing advance parameter value of 0.2 ms. After determining the timing advance parameter value, the UE 115 may adjust a transmission time associated with UL transmissions via the LP transceiver 416 and during the WUS in accordance with the timing advance parameter value, such as by advancing transmission of UL transmissions according to the timing advance parameter value from a slot boundary determined based on DL signals from the network node 105.

As described with reference to FIGS. 4-5, the present disclosure provides techniques for supporting configuration of UL control signaling and/or UL timing adjustment for a multi-transceiver device. For example, the UE 115 may be configured, through selection of the transmit parameters 472 included in the configuration 470 by the network node 105, to support one or more types of UL control signaling during WUS monitoring periods in which the UE 115 is operating in the LP mode. During a WUS monitoring period, the UE 115 may transmit the UL control signal 474 via the LP transceiver 416 to indicate the UL data/control information 476 to the network node 105, and the LP transceiver 416 may generate and transmit the UL control signal 474 using a selected set of the predefined transmission signal samples 406. Because the predefined transmission signals are relatively less complex or “simple” signals, such as OOK signals, OOK signals overlaid with OFDM sequences, or other types of less complex signals, and because the LP transceiver 416 generates the UL control signal 474 using some of the predefined transmission signal samples 406, the LP transceiver 416 is associated with a lower power consumption rate than the transceiver 414. Accordingly, the UE 115 is capable of providing UL control signaling to the network node 105 while remaining in the LP mode, and thus consuming less power, than transitioning to the normal operating mode to transmit a corresponding MAC-CE that indicates the UL data/control information 476 via the transceiver 414. In this manner, the wireless communication system 400 enables the UE 115 to reduce power consumption while also enabling the network node 105 to receive the UL data/control information 476 that can be used to improve wireless communications between the network node 105 and the UE 115 or support various functionality while the UE 115 is operating in the LP mode.

FIG. 6 is a block diagram illustrating an example of a multi-transceiver UE 600 that supports UL control signaling in accordance with the present disclosure. In some implementations, the UE 600 includes or corresponds to the UE 115 of FIGS. 1-4. In the example shown in FIG. 6, the UE 600 includes a main transceiver 602 and an LP transceiver 610. In some examples, the main transceiver 602, which may also be referred to as a primary transceiver, includes or corresponds to the transceiver 414 of FIG. 4, and the LP transceiver 610, which may also be referred to as a secondary transceiver, includes or corresponds to the LP transceiver 416 of FIG. 4.

In the example shown in FIG. 6, the main transceiver 602 and the LP transceiver 610 may share one or more components of the UE 600, in addition to including one or more respective individual components. For example, the main transceiver 602 may include a main processor 604 (and optionally, other components, such as a main transceiver memory), an RF module 606, and an antenna module 608, and the LP transceiver 610 may include an LP transceiver memory 612 and an LP transceiver processor 614 in addition to sharing use of the RF module 606 and the antenna module 608 with the main transceiver 602. The RF module 606 and the antenna module 608 may include one or more components of one or more RF chains, one or more antennas or antenna chains, or a combination thereof, similar to as described above with reference to FIG. 2. The main transceiver 602 and the LP transceiver 610 may be configured to share some components, such as the RF module 606 and the antenna module 608, to reduce an overall cost associated with the UE 600. In such an example, the shared components, such as the RF module 606 and the antenna module 608, may be used by the LP transceiver 610 at reduced capabilities, to further decrease a power consumption rate of the LP transceiver 610 as compared to a power consumption rate of the main transceiver 602.

The main processor 604 may include one or more processors or a processing system that are configured to support the operations of the main transceiver 602 (and optionally, other operations of the UE 600). The LP transceiver memory 612 and the LP transceiver processor 614 may include or correspond to a limited memory and a limited processor, respectively, that are configured to support operations of the LP transceiver 610 and that consume less power while activated than the main processor 604. For example, the LP transceiver processor 614 may have limited (or “simple”) capabilities that include supporting frequency and time synchronization operations, RSRP measurements, other such limited operations, or a combination thereof. Additionally, or alternatively, the LP transceiver memory 612 may be configured to store predefined transmission signal samples, such as the predefined transmission signal samples 406 of FIG. 4, for use in enabling the LP transceiver 610 to transmit certain UL control signaling during a WUS monitoring period. In some implementations, the LP transceiver memory 612 is also configured to store a portion or an entirety of the configuration 470.

During operation of the UE 600, if the UE 600 is operating in a normal operating mode (an active mode), the UE 600 activates the main transceiver 602 and deactivates the LP transceiver 610. While operating in the normal operating mode, the UE 600 transmits and/or receives wireless signaling or data via the main transceiver 602. In some implementations, the LP transceiver memory 612 may also be activated in order to store the predefined transmission signal samples that the UE 600 generates using the main transceiver 602.

To reduce power consumption, the UE 600 is also configured to operate in an LP mode (a sleep mode) during which the UE 600 switches off or powers down the main processor 604 (and optionally other components of the main transceiver 602 except for the RF module 606 and the antenna module 608) to reduce power consumption, in addition to activating the LP transceiver processor 614 (and optionally the LP transceiver memory 612 if the LP transceiver memory 612 is disabled). While the UE 600 is operating in the LP mode, to transmit a UL signal, the LP transceiver processor 614 accesses the LP transceiver memory 612 to retrieve a set of the predefined transmission signal samples for use in generating and transmitting the UL signal. In some examples, the UE 600 pre-generates and preprocesses one or more predefined transmission signals and stores samples of these preprocessed signals in the LP transceiver memory 612 as one or more waveforms, such as by storing I/Q samples of the preprocessed signals that represent real and imaginary components of a respective complex-valued baseband signal.

Because the LP transceiver memory 612 is limited, the signals that are sampled by the UE 600 are relatively simple and are capable of being pre-generated and stored as samples in the LP transceiver memory 612, such as signals that are generated in accordance with mathematical sequences such as a ZC sequence or an m-sequence, or signals that are transmitted across multiple subbands for the purpose of indicating whether the subbands are “powered,” such as if detectable signal present within the subbands or not without decoding the actual signal. To transmit the UL control signaling via the LP transceiver 610, the LP transceiver processor 614 retrieves a set of predefined transmission signal samples having one or more parameter values that match determined parameter values associated with aspects of the UL control signal to be sent, and the LP transceiver processor 614 provides a signal based on the retrieved set of predefined transmission signal samples to the RF module 606 and the antenna module 608 for transmission, such as to the network node 105 of FIG. 4.

FIG. 7 is a block diagram illustrating an example of a UE capability message 700 in accordance with the present disclosure. In some implementations, the UE capability message 700 includes or corresponds to the capability message 478 of FIG. 4. In some examples, the UE capability message 700 is an RRC message that is communicated via RRC signaling by a UE to a network node, such as the UE 115 and the network node 105, respectively.

In the example shown in FIG. 7, the UE capability message 700 includes a secondary transceiver capability field 702, a buffer status report capability field 704, a power headroom report capability field 706, a beam failure recovery capability field 708, and a timing advance capability field 710. In other examples, the UE capability message 700 may include fewer than five fields, more than five fields, one or more different fields than shown in FIG. 7, one or more of the fields 702-710 may be omitted, or a combination thereof.

The secondary transceiver capability field 702 indicates whether the UE supports an LP mode in addition to a normal operating mode. For example, if the secondary transceiver capability field 702 has a first value, such as a logical zero value, the secondary transceiver capability field 702 indicates that the UE does not include an LP transceiver, also referred to as a secondary transceiver, and thus supports the normal operating mode but not the LP mode. In this example, if the secondary transceiver capability field 702 has a second value, such as a logical one value, the secondary transceiver capability field 702 indicates that the UE includes the LP transceiver and thus supports both the normal operating mode and the LP mode. In some implementations, the secondary transceiver capability field 702 may include or correspond to a bit or a flag that indicates whether the UE supports the LP mode (or whether the UE includes a respective LP transceiver).

The buffer status report capability field 704 indicates one or more parameters associated with transmitting a buffer status report by the UE using the LP transceiver. For example, the buffer status report capability field 704 may include a periodicity capability subfield 712 that indicates a periodicity of buffer status reports that can be sent by the UE via the LP transceiver. Although the buffer status report capability field 704 is shown in FIG. 7 as including one subfield, in other examples, the buffer status report capability field 704 may include more than one subfield, one or more different subfields than shown in FIG. 7, or a combination thereof.

The power headroom report capability field 706 indicates one or more parameters associated with transmitting a power headroom report by the UE using the LP transceiver. For example, the power headroom report capability field 706 may include a periodicity capability subfield 714 that indicates a periodicity of power headroom reports that can be sent by the UE via the LP transceiver. Although the power headroom report capability field 706 is shown in FIG. 7 as including one subfield, in other examples, the power headroom report capability field 706 may include more than one subfield, one or more different subfields than shown in FIG. 7, or a combination thereof.

The beam failure recovery capability field 708 indicates one or more parameters associated with transmitting a beam failure recovery message by the UE using the LP transceiver. For example, the beam failure recovery capability field 708 may include a maximum number of beams subfield 716 that indicates a maximum number of beams that are supported at the UE. Although the beam failure recovery capability field 708 is shown in FIG. 7 as including one subfield, in other examples, the beam failure recovery capability field 708 may include more than one subfield, one or more different subfields than shown in FIG. 7, or a combination thereof.

The timing advance capability field 710 indicates one or more parameters associated with timing advance commands received by the UE using the LP transceiver. For example, the timing advance capability field 710 may include a preamble type subfield 718, a post-WUS delay subfield 720, and a transmitter type subfield 722. The preamble type subfield 718 indicates a type of preamble that may be transmitted by the UE via the LP transceiver to trigger a timing advance command at a network node. The post-WUS delay subfield 720 indicates a time period between activation of the LP transceiver and a time at which the LP transceiver is capable of performing wireless communications, also referred to as a “ramp up” period. The transmitter type subfield 722 indicates a type of LP transmitter or transmission waveform supported by the UE. For example, the UE may support one or more types of LP transmitters or transmission waveforms, such as an OOK transmitter or OOK waveform, an OOK waveform overlaid with an OFDM sequence, an OFDM transmitter or OFDM waveform, or another type of LP transmitter or transmission waveform. In some implementations, an OOK transmitter may be capable of transmitting signals varying only in amplitude but not phase, but an OFDM transmitter may be capable of transmitting signals varying in both amplitude and phase. Although the timing advance capability field 710 is shown in FIG. 7 as including three subfields, in other examples, the timing advance capability field 710 may include fewer than three subfields, more than three subfields, one or more different subfields than shown in FIG. 7, or a combination thereof.

FIG. 8 is a block diagram illustrating an example of a configuration 800 associated with an LP transceiver in accordance with the present disclosure. In some implementations, the configuration 800 includes or corresponds to the configuration 470 of FIG. 4. In some examples, the configuration 800 is an RRC message that is communicated via RRC signaling by a network node to a UE, such as the network node 105 and the UE 115, respectively.

In the example shown in FIG. 8, the configuration 800 includes a buffer status report parameters field 802, a power headroom report parameters field 804, a beam failure recovery parameters field 806, and a timing advance parameters field 808. In other examples, the configuration 800 may include fewer than four fields, more than four fields, one or more different fields than shown in FIG. 8, one or more of the fields 802-808 may be omitted, or a combination thereof.

The buffer status report parameters field 802 indicates one or more transmit parameters that are to be used by the UE when transmitting a buffer status report message as UL control signaling using the LP transceiver. For example, the buffer status report parameters field 802 may include a report periodicity subfield 810, a report resources subfield 812, and a post-WUS delay subfield 814. In some implementations, the buffer status report parameters field 802 may also include a flag that indicates that the UE is to transmit a buffer status report using the LP transceiver, which may also act as an instruction to pre-generate and store predefined UL control signal samples in an LP transceiver memory (or another location associated with storage of sample data for use by the LP transceiver). The report periodicity subfield 810 indicates a periodicity of the buffer status report(s) to be transmitted by the UE. The report resources subfield 812 indicates one or more wireless resources, such as physical resource blocks, subcarrier spacing (SCS), or a combination thereof, to be used by the UE to transmit the buffer status report message. The post-WUS delay subfield 814 indicates a time period between activation of the LP transceiver and a time at which the LP transceiver is capable of performing wireless communications, such as monitoring for a UL resource grant from a network node.

Although the buffer status report parameters field 802 is shown in FIG. 8 as including three subfields, in other examples, the buffer status report parameters field 802 may include fewer than three subfields, more than three subfields, one or more different subfields than shown in FIG. 8, or a combination thereof. As a non-limiting example, in some implementations, the buffer status report parameters field 802 may include one or more transmit parameters, such as one or more of the transmit parameters 472 of FIG. 4, that are associated with generation of the UL control signal that represents the buffer report message. For example, the buffer status report parameters field 802 may include one or more subfields that indicate a transmit parameter value associated with buffer status report messages, one or more transmit parameter values associated with one or more buffer sizes or buffer size ranges to be indicated by the buffer status report messages, one or more parameter values associated with one or more LCGs associated with buffer status report messages, or a combination thereof.

In this example, the buffer status report parameters field 802 may indicate one or more values of a first parameter that indicate whether a UL control signal is a buffer status report message (or alternatively, that indicates one or more parameter values associated with LCGs associated with the reported buffer size in the buffer status report message), one or more values of a second parameter that indicate which buffer size or buffer size range is being reported by the buffer status report message, other control information or parameters associated with the buffer status report message, or a combination thereof. In some examples, the first parameter may include or correspond to a root index value of a ZC sequence, a primitive polynomial of an m-sequence, an index value of another mathematical sequence, a first set of subcarriers, another parameter, or a combination thereof. Additionally, or alternatively, the second parameter may include or correspond to a cyclic shift of a ZC sequence, an m-sequence, or another mathematical sequence, a second set of subcarriers, another parameter, or a combination thereof.

The power headroom report parameters field 804 indicates one or more transmit parameters that are to be used by the UE when transmitting a power headroom report as a UL control signal using the LP transceiver. For example, the power headroom report parameters field 804 may include a report periodicity subfield 816, a path loss change threshold subfield 818, and a report resources subfield 820. In some implementations, the power headroom report parameters field 804 may also include a flag that indicates that the UE is to transmit a power headroom report as a UL control signal using the LP transceiver, which may also act as an instruction to pre-generate and store predefined UL control signal samples in an LP transceiver memory (or another location associated with storage of sample data for use by the LP transceiver).

The report periodicity subfield 816 indicates a periodicity of the power headroom report(s) to be transmitted by the UE. The path loss change threshold subfield 818 indicates a path loss threshold that, if a path loss detected by the UE satisfies the path loss threshold, the UE is to transmit the power headroom report. Although the example shown in FIG. 8 includes both the report periodicity subfield 816 and the path loss change threshold subfield 818, in some implementations, only one of the subfields 816-818 is included in the power headroom report parameters field 804. For example, if the UE is to be configured to periodically transmit a power headroom report, the power headroom report parameters field 804 includes the report periodicity subfield 816. Alternatively, if the UE is to be configured to transmit a power headroom report if a detected path loss satisfies a path loss threshold, the power headroom report parameters field 804 includes the path loss change threshold subfield 818. The report resources subfield 820 indicates one or more wireless resources, such as physical resource blocks, SCS, or a combination thereof, to be used by the UE to transmit the power headroom report message. Although the power headroom report parameters field 804 is shown in FIG. 8 as including three subfields, in other examples, the power headroom report parameters field 804 may include fewer than three subfields, more than three subfields, one or more different subfields than shown in FIG. 8, or a combination thereof. For example, similar to as described above with reference to the buffer status report parameters field 802, the power headroom report parameters field 804 may include one or more parameter values that are associated with a power headroom report, one or more UE IDs associated with the power headroom report, one or more power headroom values or power headroom ranges, other parameters of a power headroom report, or a combination thereof.

The beam failure recovery parameters field 806 indicates one or more transmit parameters that are to be used by the UE when transmitting a beam failure recovery message as a UL control signal using the LP transceiver. For example, the beam failure recovery parameters field 806 may include an RSRP limit subfield 822 and a number of beam failures subfield 824. In some implementations, the beam failure recovery parameters field 806 may also include a flag that indicates that the UE is to transmit an beam failure recovery message using the LP transceiver, which may also act as an instruction to pre-generate and store predefined UL control signal samples in an LP transceiver memory (or another location associated with storage of sample data for use by the LP transceiver). The RSRP limit subfield 822 indicates an RSRP threshold that, if the UE detects that an RSRP associated with a beam fails to satisfy the RSRP threshold, the UE is to switch to another beam or to transmit the beam failure recovery message if a threshold number of beam failures has been detected. The number of beam failures subfield 824 indicates the threshold number of beam failures that are to be detected by the UE before transmitting the beam recovery message. Although the beam failure recovery parameters field 806 is shown in FIG. 8 as including two subfields, in other examples, the beam failure recovery parameters field 806 may include fewer than two subfields, more than two subfields, one or more different subfields than shown in FIG. 8, or a combination thereof. For example, similar to as described above with reference to the buffer status report parameters field 802, the beam failure recovery parameters field 806 may include one or more parameter values that are associated with a beam failure recovery message, one or more UE IDs associated with the beam failure recovery message, one or more beam IDs, other parameters of a beam failure recovery message, or a combination thereof.

The timing advance parameters field 808 indicates one or more parameters that are to be used by the UE when performing UL timing adjustment based on a timing advance command represented by a signal received using the LP transceiver. For example, the timing advance parameters field 808 may include a TAG assignment subfield 826 and a timing advance (TA) resources subfield 828. In some implementations, the timing advance parameters field 808 may also include a flag that indicates that the UE is to UL timing adjustment in accordance with receiving a timing advance command using the LP transceiver, which may also act as an instruction to pre-generate and store predefined control signal samples in an LP transceiver memory (or another location associated with storage of sample data for use by the LP transceiver) to be used to decode the timing advance command and the associated timing advance parameter value. The TAG assignment subfield 826 indicates TAG group to which the UE is assigned. The TA resources subfield 828 indicates one or more wireless resources, such as physical resource blocks, SCS, or a combination thereof, to be monitored by the UE to receive the timing advance command. Although the timing advance parameters field 808 is shown in FIG. 8 as including two subfields, in other examples, the timing advance parameters field 808 may include fewer than two subfields, more than two subfields, one or more different subfields than shown in FIG. 8, or a combination thereof. For example, similar to as described above with reference to the buffer status report parameters field 802, the timing advance parameters field 808 may include one or more parameter values that are associated with a timing advance command, one or more TAG IDs associated with the timing advance command, one or more timing advance parameter values, other parameters of a timing advance command, or a combination thereof.

FIG. 9 is a diagram illustrating an example 900 of selecting predetermined transmission signal samples for use in generating a UL control signal by a multi-transceiver UE in accordance with the present disclosure. The example 900 includes operations that may be performed by a UE, such as the UE 115 of FIGS. 1-4 or the UE 600 of FIG. 6.

In the example 900, an LP transceiver memory 902 stores predefined control signal samples that are generated by the UE during a normal operating mode using a transceiver to enable transmission of UL control signals during an LP mode via an LP transceiver. In some examples, the LP transceiver memory 902 may include or correspond to the memory 404 of FIG. 4 (or a portion thereof) or the LP transceiver memory 612 of FIG. 6. The predefined control signal samples include multiple sets of samples that are each associated with a respective control signal that is generated and sampled using the transceiver during the normal operating mode. For example, the predefined control signal samples include a first set of samples 904 associated with a first control signal 912, a second set of samples 906 associated with a second control signal 914, a third set of samples 908 associated with a third control signal 916, and a fourth set of samples 910 associated with a fourth control signal 918.

In the example 900, the predefined control signals are to be used to communicate buffer status report messages by the UE to a network node. Accordingly, various predefined control signals having different parameters are generated and sampled, such that the various parameters of the predefined control signals can be used to indicate information related to the buffer status report. In the example 900 of FIG. 9, the predefined control signals are generated using ZC sequences that are each associated with a respective root sequence index (a first parameter) and a respective cyclic shift that is applied to the ZC sequence (a second parameter), and one or both of these parameter values may be different between the control signals 912-918. For example, the first control signal 912 may be associated with a root sequence index 920 that has a first index value (“1” in FIG. 9) and a cyclic shift 922 that has a first shift value (“1” in FIG. 9), the second control signal 914 may be associated with a root sequence index 924 that has the first index value and a cyclic shift 926 that has a second shift value (“2” in FIG. 9), the third control signal 916 may be associated with a root sequence index 928 that has a second index value (“2” in FIG. 9) and a cyclic shift 930 that has the second shift value, and the fourth control signal 918 may be associated with a root sequence index 932 that has the second index value and a cyclic shift 934 that has the second shift value. In other examples, the control signals 912-918 may be associated with different root sequence index values and/or different cyclic shift values.

The first and second parameters (the root sequence index values and the cyclic shift values, respectively) may be associated with or mapped to various parameter values or information associated with buffer status report messages by buffer status report parameters 940. The buffer status report parameters 940 may be indicated by a configuration received by the UE, such as the configuration 470 of FIG. 4 or the configuration 800 of FIG. 8, and the buffer status report parameters 940 may include or correspond to the transmit parameters 472 of FIG. 4. Although this example is described in the context of buffer status report messaging by the UE, in other aspects, the concepts described with reference to FIG. 9 may be applied to other types of UL control signaling from the UE, such as power headroom reports and beam failure recovery messages, or to DL control signaling such as timing advance commands, as non-limiting examples.

In the example 900 shown in FIG. 9, the root sequence index associated with a ZC sequence used to generate an UL control signal is used to indicate a LCG ID for which a buffer size range is being reported, and the cyclic shift applied to the ZC sequence is used to indicate a buffer size range reported by the UE. In this example, the first index value is associated with a first LCG ID (“LCG_1”), the second index value is associated with a LCG ID (“LCG_2”), a jth index value is associated with a jth LCG ID (“LCG_j”), the first shift value is associated with a first buffer size range (“Buffer Size Range_1”), the second shift value is associated with a second buffer size range (“Buffer Size Range_2”), and a kth shift value is associated with a kth buffer size range (“Buffer Size Range_k”). In this example, j and k are each any positive integer greater than two. In some other examples, the root sequence index values may be associated with different LCG IDs and/or the cyclic shift values may be associated with different buffer size ranges, which are indicated by the buffer status report parameters 940. In some other implementations, the parameters of the control signals 912-914 may be used to indicate other parameters or characteristics of the buffer status report. As an example, in some implementations, the root sequence index values may be used to indicate a message type of a UL control signal by the UE. In such an example, the first index value may indicate a buffer status report message, the second index value may indicate a power headroom report message, a third index value may indicate a beam failure recover message, and the jth index value may indicate a timing advance command.

While operating in the LP mode, the UE may determine to send a buffer status report, such as based on a periodicity associated with the buffer status report or based on receiving an explicit instruction from the network node. In the example 900, the buffer status report 942 indicates that a buffer associated with the first LCG ID has a size that is within the second buffer size range. To transmit a UL control signal to the network node that represents the buffer status report 942, the UE determines a root sequence index value (a first parameter value) and a cyclic shift value (a second parameter value) in accordance with the buffer status report parameters 940. For example, because the buffer status report 942 is associated with the first LCG ID, the UE determines that a UL control signal to be sent is associated with the first index value based on the association between the first LCG ID and the first index value indicated by the buffer status report parameters 940. Similarly, because the buffer status report 942 indicates that the buffer size is within the second buffer size range, the UE determines that the UL control signal to be sent is associated with the second shift value based on the association between the second buffer size range and the second shift value indicated by the buffer status report parameters 940. Although an example of determining associations between two aspects of a buffer status report and two parameters of a UL control signal is described, in other examples, associations between more than two aspects of a buffer status report and parameters of the UL control signal or between a single aspect of a buffer status report and a parameter of the UL control signal may be determined by the UE.

After determining the root sequence index value and the cyclic shift value that are associated with the LCG ID and the buffer size of the buffer status report 942, the UE may access the LP transceiver memory 902 to select a set of samples that correspond to a control signal having the determined parameter values. For example, the UE may select the second set of samples 906 that corresponds to the second control signal 914 for which the root sequence index 924 is the first index value (that is associated with the first LCG ID) and the cyclic shift 926 is the second shift value (that is associated with the second buffer size range). The UE may use the LP transceiver to generate the second control signal 914 in accordance with the second set of samples 906 for transmission to the network node as a UL control signal. Because the LP transceiver generates the UL control signal using the second set of samples 906, instead of processing and generating the UL control signal without pre-stored samples, the LP transceiver is able to generate and send the UL control signal while consuming less power than if the UL control signal was generated and sent by the transceiver during the normal operating mode, thereby reducing power consumption of the UE and prolonging the battery life of the UE.

Although the operations of the example 900 of FIG. 9 are described for predefined control signals that are generated using ZC sequences, in other examples, similar operations may be performed for predefined control signals that are generated using other mathematical sequences, such as an m-sequence. For example, instead of associating various LCG IDs with various root sequence indices of ZC sequences, the buffer status report parameters 940 may associate the various LCG IDs with primitive polynomials associated with m-sequences used to generate the control signals 912-918. In such an example, the various buffer size ranges are associated with various cyclic shifts applied to the m-sequences.

Alternatively, the buffer status report parameters 940 may associate the various LCG IDs and the various buffer size ranges with sets of subcarriers via which the control signals 912-918 are to be sent by the UE using the LP transceiver. For example, instead of associating various LCG IDs with various root sequence indices of ZC sequences, the buffer status report parameters 940 may associate the various LCG IDs with different subcarriers of a first set of subcarriers used to transmit the control signals 912-918. In such an example, the various buffer size ranges are associated with second subcarriers of a second set of subcarriers used to transmit the control signals 912-918. For example, each subcarrier of the second set of subcarriers may be associated with a different buffer size range. In such an example, the LCG ID of the buffer status report is associated with at least one first subcarrier of a first set of subcarriers, the buffer size range is associated with at least one second subcarrier of a second set of subcarriers, and the UL control signal is transmitted via the at least one first subcarrier and the at least one second subcarrier. In other examples, different combinations of subcarriers of the second set of subcarriers may each correspond to a different buffer size range. In still other examples, other parameters can be indicated by sets of subcarriers. In some embodiments, a parameter having a multi-bit value may be represented the subcarriers of a set of subcarriers that are used to transmit the UL control signal, also referred to as which of the set of subcarriers are “active subcarriers”. For example, if the second set of subcarriers include six subcarriers, whether or not each subcarrier is active (the signal is active, to indicate a value of “1”) or is not active (the signal is not detected in this subcarrier, to indicate a value of “0”) can be used to collectively represent a six-bit value.

FIG. 10 is a ladder diagram of an example of operations 1000 that support transmission of a UL control signal by a multi-transceiver UE in accordance with the present disclosure. In some aspects, the operations 1000 are performed by the UE 115 and the network node 105 described with reference to FIGS. 1-4, or the UE 600 of FIG. 6.

The operations begin at 1002, in which the UE 115 enters into an active mode, also referred to as a normal operating mode. While operating in the active mode, the transceiver 414 may be active and the LP transceiver 416 may be powered down. The UE 115 may perform wireless communications using the transceiver 414 while operating in the active mode.

At 1004, the UE 115 sends a capability message to network node 105. For example, the UE 115 may send the capability message 478 via the transceiver 414. The capability message 478 may indicate one or more multi-transceiver UL control signaling capabilities of the UE 115, such as a buffer status report capability, a power headroom report capability, a beam failure recovery capability, or a timing advance capability, as further described above with reference to FIG. 7. In this example, the capability message 478 indicates one or more buffer status report message parameters.

At 1006, the network node 105 sends a configuration to UE 115. For example, the network node may send the configuration 470 to the UE 115, and the UE 115 may receive the configuration 470 via the transceiver 414. The configuration 470 indicates the transmit parameters 472 that are configured for the UE 115 to enable transmission of one or more types of UL control signaling during one or more WUS monitoring periods. Additional details of the configuration 470 are described above with reference to FIG. 8. In this example, the configuration 470 indicates one or more buffer status report message parameters.

At 1008, the UE 115 transitions to an LP mode for a WUS monitoring period. For example, the UE 115 may deactivate or power down the transceiver 414 and activate the LP transceiver 416 for performing wireless communications while operating in the LP mode. The UE 115 may be configured to operate in the LP mode for a duration of a WUS monitoring period, unless the UE 115 receives a WUS from the network node 105 that instructs the UE 115 to transition to the active mode or the UE 115 determines to transition to the active mode. The WUS monitoring period may have a duration that is predefined at the UE 115 and the network node 105 or that is configured at the UE 115 by the network node 105, such as via RRC signaling. In some embodiments, the WUS monitoring period is defined in one or more wireless communication standards and is preconfigured at the UE 115 and the network node 105.

At 1010, the UE 115 detects UL control information for transmission to the network node 105 as a UL control signal, and the UE 115 detects a message type associated with the UL control signal. For example, an application being executed by the UE 115 may generate control information that is to be sent to the network node 105 or the UE 115 may determine a change in a channel condition or other situation associated with sending control information to the network node 105. In some examples, the UE 115 detects that a buffer status report is to be transmitted based on a periodicity parameter associated with buffer status reports or based on receipt of a request message from the network node 105. In such examples, the UE 115 determines that the message type 475 is a buffer status message, and the UL data/control information 476 information is a buffer size that indicates a number of UL transmissions to be sent to the network node 105 via a configured UL grant. The UE 115 may identify a first parameter value and a second parameter value, such as an index value of a mathematical sequence and a cyclic shift applied to the mathematical sequence, that are associated with the message type 475 and the UL data/control information 476, respectively. For example, the transmit parameters 472 may include multiple index values (or other parameter values) that are respectively associated with multiple message types and multiple cyclic shifts (or other parameter values) that are associated with buffer report sizes or size ranges, and the UE 115 may identify the parameter values that are associated with the identified message type 475 (or other control signal parameter) and buffer size represented by the UL data/control information 476 (or other control information).

At 1012, the UE 115 generates a UL control signal in accordance with first and second parameter values. For example, the UE 115 may access the memory 404 to select a set of the predefined transmission signal samples 406 that correspond to the first parameter value and to the second parameter value, and the UE 115 may generate the UL control signal 474 in accordance with the selected set of the predefined transmission signal samples 406. As an illustrative example, if the transmit parameters 472 indicate that buffer status reports are associated with a first index value and that the identified buffer size is within a second buffer size range that is associated with a second cyclic shift value, the UE 115 may select the set of the predefined transmission signal samples 406 that is associated with the first index value and the second cyclic shift value to generate the UL control signal 474.

At 1014, the UE 115 sends the UL control signal 474 via the LP transceiver 416 to the network node 105. For example, the UE 115 may send the UL control signal 474 via the LP transceiver 416, and parameters of the UL control signal 474 may indicate the message type 475 and the UL data/control information 476 associated with a buffer status report message.

At 1016, the network node 105 sends a WUS to the UE 115 in accordance with the received UL control signal. For example, the network node 105 may send the WUS 480 to the UE 115, and the UE 115 may receive the WUS 480 via the LP transceiver 416. In the example in which the UL control signal 474 is a buffer status report, the WUS 480 may include an instruction to the UE 115 to transition to the active mode and to monitor with the transceiver 414 to receive a UL resource grant to schedule transmission of the UL data stored in the buffer associated with the buffer status report. Additionally, or alternatively, the WUS 480 may indicate one or more updated parameters to be used by the UE 115.

FIG. 11 is a ladder diagram of an example of operations 1100 that support UL timing adjustment by a multi-transceiver UE in accordance with the present disclosure. In some aspects, the operations 1100 are performed by the UE 115 and the network node 105 described with reference to FIGS. 1-4 and 10, or the UE 600 of FIG. 6.

The operations begin at 1102, in which the UE 115 enters into an active motive, as described above with reference to FIG. 10. At 1104, the UE 115 sends a capability message via the transceiver 414 to network node 105. For example, the UE 115 may send the capability message 478 via the transceiver 414. The capability message 478 may indicate one or more multi-transceiver UL control signaling capabilities of the UE 115, such as a buffer status report capability, a power headroom report capability, a beam failure recovery capability, or a timing advance capability. In this example, the capability message 478 indicates one or more timing advance capabilities, as further described above with reference to FIG. 7.

At 1106, the network node 105 sends a configuration via the transceiver 414 to UE 115. For example, the network node 105 may send the configuration 470 to the UE 115, and the UE 115 may receive the configuration 470 via the transceiver 414. The configuration 470 indicates the transmit parameters 472 that are configured for the UE 115 to enable transmission of one or more types of UL control signaling during one or more WUS monitoring periods. Additional details of the configuration 470 are described above with reference to FIG. 8. In this example, the configuration 470 indicates one or more timing advance parameters.

At 1108, the UE 115 transitions to an LP mode for a WUS monitoring period, as described above with reference to FIG. 10. At 1110, in some implementations, the network node 105 sends a PRACH preamble request to the UE 115, and the UE 115 receives the PRACH preamble request via the LP transceiver 416. For example, if the UE 115 is configured to provide a PRACH preamble in response to receipt of a request message (or another form of explicit indicator) from the network node 105 during the WUS, the network node 105 may send the PRACH preamble request to the UE 115 during the WUS as the request message. In some other implementations, the UE 115 is configured to transmit a PRACH preamble in accordance with a periodic schedule or with a configuration indicated by the configuration 470. At 1112, the UE 115 sends a PRACH preamble via the LP transceiver 416 to the network node 105. For example, the UE 115 may transmit the UL control signal 474 via the LP transceiver 416 and during the WUS monitoring period, and the UL control signal 474 may indicate or correspond to a PRACH preamble.

At 1114, the network node 105 sends a control signaling indicator to the UE 115. For example, the network node 105 may send the WUS 480 that includes the control signaling indicator 482 to the UE 115 during the WUS monitoring period, and the UE 115 may receive the WUS 480 via the LP transceiver 416. The control signaling indicator 482 indicates whether control signaling is to be communicated by the network node 105 (such as in addition to or after any control information included in or indicated by the WUS 480). In the example shown in FIG. 11, the network node 105 sends the WUS 480 that includes the control signaling indicator 482 in accordance with receipt of the PRACH preamble indicated by or represented by the UL control signal 474 from the UE 115 at 1112. In some examples, the control signaling indicator 482 includes a control bit of a message received via the LP transceiver 416 during the WUS monitoring period, such as a control bit of the WUS 480, or an implicit indicator associated with the WUS 480 such as an OFDM sequence that is overlaid on the WUS 480.

At 1116, the network node 105 sends a DL control signal indicating a UL timing advance parameter to the UE 115. For example, if the control signaling indicator 482 indicates that control signaling is to be communicated from the network node 105, the network node 105 may send the DL control signal 484 that indicates a timing advance command to the UE 115 during the WUS monitoring period, and the UE 115 may receive the DL control signal 484 via the LP transceiver 416. The UE 115 may identify, in accordance with the configuration 470, a timing advance parameter value associated with a parameter value of the DL control signal 484. For example, various cyclic shift values may be respectively associated with various timing advance parameter values by the configuration 470, and the UE 115 may identify the timing advance parameter value that is associated with a cyclic shift value of the DL control signal 484.

At 1118, the UE 115 adjusts UL timing in accordance with the timing advance parameter value. For example, the UE 115 may adjust a transmission time associated with one or more UL transmission signals via the LP transceiver 416 and during the WUS monitoring period. In such an example, instead of transmitting the UL signals at a slot boundary determined based on receipt of signals from the network node 105, the UE 115 may transmit the transmission signals at a time prior to the slot boundary, with a duration between the transmission time and the slot boundary being represented by the timing advance parameter value. At 1120, the UE 115 sends a UL transmission signal to the network node 105 in accordance with the adjusted UL timing. In this example, the UL transmission signal is sent via the LP transceiver 416, such that the UE 115 is able to perform UL timing adjustment while operating in the LP mode.

FIG. 12 is a flow diagram illustrating an example process 1200 that supports UL control signaling by a multi-transceiver device in accordance with the present disclosure. Operations of the process 1200 may be performed by a UE, such as the UE 115 described above with reference to FIGS. 1-4 and 10-11 or the UE 600 of FIG. 6. For example, example operations (also referred to as “blocks”) of the process 1200 may enable the UE to support UL control signaling by a multi-transceiver device, according to some aspects of the present disclosure.

FIG. 13 is a flow diagram illustrating an example process 1300 that supports UL timing adjustment by a multi-transceiver device in accordance with the present disclosure. Operations of the process 1300 may be performed by a UE, such as the UE 115 described above with reference to FIGS. 1-4 and 10-11 or the UE 600 of FIG. 6. For example, example operations (also referred to as “blocks”) of the process 1300 may enable the UE to support UL timing adjustment by a multi-transceiver device, according to some aspects of the present disclosure.

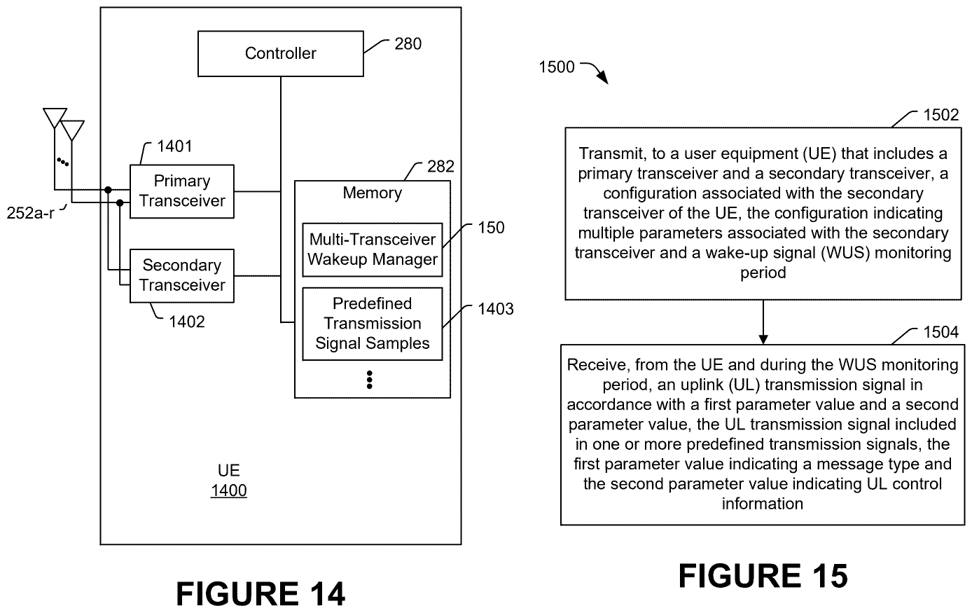

FIG. 14 is a block diagram of an example UE 1400 that supports UL control signaling and UL timing adjustment by a multi-transceiver device in accordance with the present disclosure. The UE 1400 may be configured to perform operations, including the blocks of the process 1200 described with reference to FIG. 12, to perform UL control signaling for a multi-transceiver device. Additionally, or alternatively, the UE 1400 may be configured to perform operations, including the blocks of the process 1300 described with reference to FIG. 13, to perform UL timing adjustment by a multi-transceiver device. In some implementations, the UE 1400 includes the structure, hardware, and components shown and described with reference to the UE 115 of FIGS. 1-4 and 10-11 or the UE 600 of FIG. 6. For example, the UE 1400 includes the controller 280, which operates to execute logic or computer instructions stored in the memory 282, as well as controlling the components of the UE 1400 that provide the features and functionality of the UE 1400. The UE 1400, under control of the controller 280, transmits and receives signals via a primary transceiver 1401 and a secondary transceiver 1402 and the antennas 252a-r. The primary transceiver 1401 and the secondary transceiver 1402 include various components and hardware, as illustrated in FIG. 2 for the UE 115, including the modems 254a-r, the MIMO detector 256, the receive processor 258, the transmit processor 264, and the TX MIMO processor 266. In some embodiments, the primary transceiver 1401 includes or corresponds to the transceiver 414 of FIG. 4 or the main transceiver 602 of FIG. 6, and the secondary transceiver 1402 includes or corresponds to the LP transceiver 416 of FIG. 4 or the LP transceiver 610 of FIG. 6. The UE 1400 may be configured to perform wireless communications during a normal operating mode using the primary transceiver 1401 and to perform wireless communications during a LP mode using the secondary transceiver 1402.

As shown, the memory 282 may include the multi-transceiver wakeup manager 150 and predefined transmission signal samples 1403. Although illustrated in FIG. 14 as being included in the memory 282, in other implementations, the multi-transceiver wakeup manager 150 may be a separate component of the UE 1400. The multi-transceiver wakeup manager 150 may be configured to manage one or more operations supporting UL control signal transmission by a multi-transceiver device, such as transmitting, via the secondary transceiver 1402 and during a WUS monitoring period, a UL control signal using a set of samples selected, in accordance with one or more transmit parameters, from the predefined transmission signal samples 1403. The predefined transmission signal samples 1403 may include or correspond to the predefined transmission signal samples 406 of FIG. 4 and/or the sets of samples 904-910 of FIG. 9. The UE 1400 may receive signals from or transmit signals to one or more network nodes, such as the network node 105 of FIGS. 1-4 and 10-11 or a network node as illustrated in FIG. 17.

Referring back to the process 1200 of FIG. 12, in block 1202, the UE 1400 receives, via a primary transceiver of the UE and from a network node, a configuration associated with a secondary transceiver of the UE. For example, the configuration may include or correspond to the configuration 470 of FIG. 4, the primary transceiver may include or correspond to the transceiver 414 of FIG. 4, and the secondary transceiver may include or correspond to the LP transceiver 416 of FIG. 4.

In block 1204, the UE 1400 identifies, in accordance with the configuration, a first parameter value that indicates a message type and a second parameter value that indicates UL control information. For example, the message type may include or correspond to the message type 475 of FIG. 4, and the UL control information may include or correspond to the UL data/control information 476 of FIG. 4. The first parameter value and the second parameter value may be determined in accordance with the transmit parameters 472 as described with reference to FIGS. 4-5. In some implementations, the message type 475 corresponds to one of a buffer status report, a beam failure recovery message, or a power headroom report.

In block 1206, the UE 1400 transmits, via the secondary transceiver, to the network node and during a WUS monitoring period, a UL transmission signal selected, in accordance with the first parameter value and the second parameter value, from one or more predefined transmission signals. For example, the UL transmission signal may include or correspond to the UL control signal 474 of FIG. 4, and the one or more predefined transmission signals (or samples thereof) may include or correspond to the predefined transmission signal samples 406 of FIG. 4 or the sets of samples 904-910 of FIG. 9. In some implementations, each of the one or more predefined transmission signals is capable of being decoded without frequency demodulation at a receiver.

In some implementations, the first parameter value indicates an index value of a mathematical sequence, and the second parameter value indicates a cyclic shift applied to the mathematical sequence. For example, the transmit parameters 472 may indicate an association between message types and index values of mathematical sequences, in addition to an association between cyclic shift values and control information. An example of selecting the first parameter value and the second parameter value in accordance with such associations is described further above with reference to FIG. 9. In some such implementations, the mathematical sequence is a ZC sequence and the first parameter value indicates a root sequence index of the ZC sequence. In some other implementations, the mathematical sequence is an m-sequence and the first parameter value indicates a primitive polynomial of the m-sequence.

In some implementations, the first parameter value indicates at least one first subcarrier of a first set of subcarriers, the second parameter value indicates at least one second subcarrier of a second set of subcarriers, and the UL transmission signal is transmitted via the at least one first subcarrier and the at least one second subcarrier. For example, at least one first subcarrier of a first set of subcarriers via which the UL control signal is transmitted may be associated with the message type, and at least one second subcarrier of a second set of subcarriers via which the UL control signal is transmitted may be associated with the UL control information. In such an example, the first set of subcarriers may represent a first multibit value having a number of bits equal to the number of subcarriers in the first set of subcarriers, and the second set of subcarriers may represent a second multibit value having a number of bits equal to the number of subcarriers in the second set of subcarriers, with each bit of the respective multibit value being based on whether the corresponding subcarrier is active or not active.

In some implementations, the process 1200 includes receiving, via the secondary transceiver and during the WUS monitoring period, a DL signal selected, in accordance with a third parameter value and a fourth parameter value, from the one or more predefined transmission signals. For example, the DL signal may include or correspond to the DL control signal 484 of FIG. 4. In such implementations, the process 1200 also includes identifying, in accordance with the configuration, a DL message type associated with the third parameter value and DL control information associated with the fourth parameter value, and adjusting, in accordance with the DL message type being a timing advance command, transmission times of one or more additional UL transmission signals during the WUS monitoring period in accordance with the DL control information. Adjusting UL transmission times in accordance with the DL control signal 484 is further described above with reference to FIG. 11.

In some implementations, the process 1200 also includes storing, at the one or more memories and prior to the WUS monitoring period, a plurality of samples each respectively associated with one of a plurality of UL transmission signals. Each of the plurality of UL transmission signals is associated with a respective first parameter that indicates a respective message type and a respective second parameter that indicates respective UL control information. For example, the plurality of samples may include or correspond to the predefined transmission signal samples 406 of FIG. 4 or the sets of samples 904-910 of FIG. 9. Such samples may be stored in a portion of the memory 404 of FIG. 4, the LP transceiver memory 612 of FIG. 6, or the LP transceiver memory 902 of FIG. 9. In such implementations, the process 1200 also includes accessing, during the WUS monitoring period, the one or more memories to identify a particular set of samples of the plurality of samples that are associated with the first parameter value associated with the UL transmission signal and the second parameter value associated with the UL transmission signal. The UL transmission signal is transmitted in accordance with the particular set of samples. For example, the second control signal 914 is generated and transmitted in accordance with selection of the second set of samples 906 based on identification of the parameter values of the buffer status report 942 and the associations between the parameters and the signal parameters indicated by the buffer status report parameters 940 of FIG. 9.

Referring to the process 1300 of FIG. 13, in block 1302, the UE 1400 receives, via a secondary transceiver of the UE and from a network node, during a WUS monitoring period when a primary transceiver of the UE is powered down, a control signaling indicator that indicates whether control signaling is to be communicated by the network node. For example, the control signal indicator may include or correspond to the control signaling indicator 482 of FIG. 4, and the primary transceiver may include or correspond to the transceiver 414 of FIG. 4.

In block 1304, the UE 1400 receives, via the secondary transceiver and from the network node, during the WUS monitoring period and in accordance with the control signaling indicator indicating that the control signaling is to be communicated, a DL control signal indicating a timing advance command. For example, the DL control signal may include or correspond to the DL control signal 484 of FIG. 4.

In block 1306, the UE 1400 identifies, in accordance with a configuration associated with the secondary transceiver, a timing advance parameter value associated with a parameter value of the DL control signal. For example, the configuration may include or correspond to the configuration 470 of FIG. 4, which may indicate associations between timing advance parameters and signal parameters of control signals, as described above with reference to FIGS. 4, 5, 8, and 11.

In block 1308, the UE 1400 adjusts, in accordance with the timing advance parameter value, a transmission time associated with one or more UL transmission signals via the secondary transceiver and during the WUS monitoring period. For example, as described above with reference to FIG. 11, the UE 115 may perform UL timing adjustment in accordance with a timing advance parameter value indicated by the DL control signal 484.

In some implementations, the process 1300 also includes transmitting, via the secondary transceiver and during the WUS monitoring period, a PRACH preamble. The control signaling indicator is received in accordance with transmission of the PRACH preamble. For example, the PRACH preamble includes or corresponds to the UL control signal 474 of FIG. 4, and the WUS 480 that indicates the control signaling indicator 482 is received by the UE 115 in accordance with transmission of the UL control signal 474. In some such implementations, the PRACH preamble is initiated in accordance with a periodic schedule. Alternatively, the PRACH preamble may be initiated in accordance with the configuration. Alternatively, the PRACH preamble may be initiated in accordance with receipt of a request message during the WUS monitoring period. Initiation of the PRACH preamble is further described above with reference to FIG. 11.

In some implementations, the control signaling indicator includes a control bit of a message received via the secondary transceiver during the WUS monitoring period. For example, the control signaling indicator 482 may include or correspond to a control bit of the WUS 480 of FIG. 4. Alternatively, the control signaling indicator 482 may include or correspond to a parameter value of the WUS 480, as further described above with reference to FIGS. 4 and 11.

FIG. 15 is a flow diagram illustrating an example process 1500 that supports configuring UL signaling by a multi-transceiver device in accordance with the present disclosure. Operations of the process 1500 may be performed by a network node, such as the network node 105 described above with reference to FIGS. 1-4 and 10-11. For example, example operations of the process 1500 may enable a network node to configure UL signaling by a multi-transceiver device.

FIG. 16 is a flow diagram illustrating an example process 1600 that supports configuring UL timing adjustment by a multi-transceiver device in accordance with the present disclosure. Operations of the process 1600 may be performed by a network node, such as the network node 105 described above with reference to FIGS. 1-4 and 10-11. For example, example operations of the process 1600 may enable a network node to configure UL timing adjustment by a multi-transceiver device.

FIG. 17 is a block diagram of an example network node 1700 that supports configuring UL control signaling and UL timing adjustment by a multi-transceiver device in accordance with the present disclosure. The network node 1700 may be configured to perform operations, including the blocks of the process 1500 described with reference to FIG. 15, to configure UL control signaling for a multi-transceiver device. Additionally, or alternatively, the network node 1700 may be configured to perform operations, including the blocks of the process 1600 described with reference to FIG. 16, to configure UL timing adjustment for a multi-transceiver device. In some implementations, the network node 1700 includes the structure, hardware, and components shown and described with reference to the network node 105 of FIGS. 1-4 and 10-11. For example, the network node 1700 may include the controller 240, which operates to execute logic or computer instructions stored in the memory 242, as well as controlling the components of the network node 1700 that provide the features and functionality of the network node 1700. The network node 1700, under control of the controller 240, transmits and receives signals via wireless radios 1701 and the antennas 234a-t. The wireless radios 1701 include various components and hardware, as illustrated in FIG. 2 for the network node 105, including the modems 232a-t, the transmit processor 220, the TX MIMO processor 230, the MIMO detector 236, and the receive processor 238.

As shown, the memory 242 may include the multi-transceiver wakeup manager 152 and transmit parameters 1702. Although illustrated in FIG. 17 as being included in the memory 242, in other implementations, the multi-transceiver wakeup manager 152 may be a separate component of the network node 1700. The multi-transceiver wakeup manager 152 may be configured to manage one or more operations supporting configuration of UL control signaling for a multi-transceiver device, such as transmitting a configuration indicating the transmit parameters 1702 associated with a secondary transceiver of a UE and a WUS monitoring period. The transmit parameters 1702 may include or correspond to the transmit parameters 472 of FIG. 4. The network node 1700 may receive signals from or transmit signals to one or more UEs, such as the UE 115 of FIGS. 1-4 and 10-11, the UE 600 of FIG. 6, or the UE 1400 of FIG. 14.

Referring back to the process 1500 of FIG. 15, in block 1502, the network node 1700 transmits, to a UE, a configuration associated with a primary transceiver of the UE and a secondary transceiver of the UE. The configuration indicates multiple parameters associated with the secondary transceiver and a WUS monitoring period. For example, the configuration may include or correspond to the configuration 470 of FIG. 4, the primary transceiver may include or correspond to the transceiver 414 of FIG. 4, and the secondary transceiver may include or correspond to the LP transceiver 416 of FIG. 4.

In block 1504, the network node 1700 receives, from the UE and during the WUS monitoring period, a UL transmission signal in accordance with a first parameter value and a second parameter value. The UL transmission signal is included in one or more predefined transmission signals, the first parameter value indicates a message type, and the second parameter value indicates UL control information. For example, the UL transmission signal may include or correspond to the UL control signal 474 that indicates message type 475 and UL data/control information 476 of FIG. 4. The first parameter value and the second parameter value may be associated with the message type 475 and the UL data/control information 476, respectively, as indicated by the transmit parameters 472.

Referring to the process 1600 of FIG. 16, in block 1602, the network node 1700 receives, from a UE and during a WUS monitoring period, a PRACH preamble. For example, the PRACH preamble may include or correspond to the UL control signal 474 of FIG. 4. In block 1604, the network node 1700 transmits, to the UE, during the WUS monitoring period in accordance with receiving the PRACH preamble, a control signaling indicator that indicates whether control signaling is to be communicated. For example, control signaling indicator may include or correspond to the control signaling indicator 482 of FIG. 4 that is included in or indicated by the WUS 480.

In block 1606, the network node 1700 transmits, to the UE, during the WUS monitoring period in accordance with the control signaling indicator indicating that the control signaling is to be communicated, a DL control signal indicating a timing advance command and an associated timing advance parameter value. For example, the DL control signal may include or correspond to the DL control signal 484 of FIG. 4, which can indicate a timing advance parameter value, as described above with reference to FIG. 11.

It is noted that one or more blocks (or operations) described with reference to FIGS. 12, 13, 15, and 16 may be combined with one or more blocks (or operations) described with reference to another of the figures. For example, one or more blocks (or operations) of FIG. 12 may be combined with one or more blocks (or operations) of FIG. 13. As another example, one or more blocks associated with any one or more of FIGS. 12, 13, 15, or 16 may be combined with one or more blocks (or operations) associated with FIGS. 1-11. Additionally, or alternatively, one or more operations described above with reference to FIGS. 1-11 may be combined with one or more operations described with reference to FIG. 14 or 17.

In the following, further examples are described to facilitate the understanding of the disclosure.

According to Example 1, a UE for wireless communication includes a processing system that includes one or more processors and one or more memories that store code and are coupled with the one or more processors. The processing system is configured to cause the UE to receive, via a primary transceiver of the UE and from a network node, a configuration associated with a secondary transceiver of the UE. The processing system is also configured to identify, in accordance with the configuration, a first parameter value that indicates a message type and a second parameter value that indicates UL control information. The processing system is also configured to transmit, via the secondary transceiver, to the network node and during a WUS monitoring period, a UL transmission signal selected, in accordance with the first parameter value and the second parameter value, from one or more predefined transmission signals.

Example 2 includes the UE of Example 1, where: each of the one or more predefined transmission signals is capable of being decoded without frequency demodulation at a receiver, and the message type corresponds to one of a buffer status report, a beam failure recovery message, or a power headroom report.

Example 3 includes the UE of Example 1 or Example 2, where: the first parameter value indicates an index value of a mathematical sequence, and the second parameter value indicates a cyclic shift applied to the mathematical sequence.

Example 4 includes the UE of Example 3, where: the mathematical sequence is a ZC sequence; and the first parameter value indicates a root sequence index of the ZC sequence.

Example 5 includes the UE of Example 3, where: the mathematical sequence is an m-sequence; and the first parameter value indicates a primitive polynomial of the m-sequence.

Example 6 includes the UE of Example 1 or Example 2, where: the first parameter value indicates at least one first subcarrier of a first set of subcarriers, the second parameter value indicates at least one second subcarrier of a second set of subcarriers, and the UL transmission signal is transmitted via the at least one first subcarrier and the at least one second subcarrier.

Example 7 includes the UE of any of Examples 1 to 6, where the processing system is further configured to cause the UE to: receive, via the secondary transceiver and during the WUS monitoring period, a DL signal selected, in accordance with a third parameter value and a fourth parameter value, from the one or more predefined transmission signals. The processing system is also configured to identify, in accordance with the configuration, a DL message type associated with the third parameter value and DL control information associated with the fourth parameter value. The processing system is also configured to adjust, in accordance with the DL message type being a timing advance command, transmission times of one or more additional UL transmission signals during the WUS monitoring period in accordance with the DL control information.

Example 8 includes the UE of any of Examples 1 to 7, where the processing system is also configured to cause the UE to: store, at the one or more memories and prior to the WUS monitoring period, a plurality of samples each respectively associated with one of a plurality of UL transmission signals, each of the plurality of UL transmission signals associated with a respective first parameter that indicates a respective message type and a respective second parameter that indicates respective UL control information. The processing system is also configured to access, during the WUS monitoring period, the one or more memories to identify a particular set of samples of the plurality of samples that are associated with the first parameter value associated with the UL transmission signal and the second parameter value associated with the UL transmission signal. The UL transmission signal is transmitted in accordance with the particular set of samples.

According to Example 9, a method of wireless communication by a UE includes receiving, via a primary transceiver of the UE and from a network node, a configuration associated with a secondary transceiver of the UE. The method also includes identifying, in accordance with the configuration, a first parameter value that indicates a message type and a second parameter value that indicates UL control information. Additionally, the method includes transmitting, via the secondary transceiver, to the network node and during a WUS monitoring period, a UL transmission signal selected, in accordance with the first parameter value and the second parameter value, from one or more predefined transmission signals.

Example 10 includes the method of Example 9, where: each of the one or more predefined transmission signals is capable of being decoded without frequency demodulation at a receiver, and the message type corresponds to one of a buffer status report, a beam failure recovery message, or a power headroom report.

Example 11 includes the method of Example 9 or Example 10, where: the first parameter value indicates an index value of a mathematical sequence; and the second parameter value indicates a cyclic shift applied to the mathematical sequence.

Example 12 includes the method of Example 11, where: the mathematical sequence is a ZC sequence; and the first parameter value indicates a root sequence index of the ZC sequence.

Example 13 includes the method of Example 11, where: the mathematical sequence is an m-sequence; and the first parameter value indicates a primitive polynomial of the m-sequence.

Example 14 includes the method of Example 9 or Example 10, where: the first parameter value indicates at least one first subcarrier of a first set of subcarriers, the second parameter value indicates at least one second subcarrier of a second set of subcarriers, and the UL transmission signal is transmitted via the at least one first subcarrier and the at least one second subcarrier.

Example 15 includes the method of any of Examples 9 to 14, and also includes receiving, via the secondary transceiver and during the WUS monitoring period, a DL signal selected, in accordance with a third parameter value and a fourth parameter value, from the one or more predefined transmission signals. The method also includes identifying, in accordance with the configuration, a DL message type associated with the third parameter value and DL control information associated with the fourth parameter value. The method also includes adjusting, in accordance with the DL message type being a timing advance command, transmission times of one or more additional UL transmission signals during the WUS monitoring period in accordance with the DL control information.

Example 16 includes the method of any of Examples 9 to 15, and also includes storing, at a memory of the UE and prior to the WUS monitoring period, a plurality of samples each respectively associated with one of a plurality of UL transmission signals. Each of the plurality of UL transmission signals is associated with a respective first parameter that indicates a respective message type and a respective second parameter that indicates respective UL control information. The method also includes accessing, during the WUS monitoring period, the memory to identify a particular set of samples of the plurality of samples that are associated with the first parameter value associated with the UL transmission signal and the second parameter value associated with the UL transmission signal. The UL transmission signal is transmitted in accordance with the particular set of samples.

According to Example 17, a UE for wireless communication includes a processing system that includes one or more processors and one or more memories that store code and are coupled with the one or more processors. The processing system is configured to cause the UE to receive, via a secondary transceiver of the UE and from a network node, during a WUS monitoring period when a primary transceiver of the UE is powered down, a control signaling indicator that indicates whether control signaling is to be communicated by the network node. The processing system is also configured to receive, via the secondary transceiver and from the network node, during the WUS monitoring period and in accordance with the control signaling indicator indicating that the control signaling is to be communicated, a DL control signal indicating a timing advance command. The processing system is also configured to identify, in accordance with a configuration associated with the secondary transceiver, a timing advance parameter value associated with a parameter value of the DL control signal. The processing system is also configured to adjust, in accordance with the timing advance parameter value, a transmission time associated with one or more UL transmission signals via the secondary transceiver and during the WUS monitoring period.

Example 18 includes the UE of Example 17, where the processing system is also configured to cause the UE to transmit, via the secondary transceiver and during the WUS monitoring period, a PRACH preamble. The control signaling indicator is received in accordance with transmission of the PRACH preamble.

Example 19 includes the UE of Example 18, where the PRACH preamble is initiated in accordance with: a periodic schedule, the configuration, or receipt of a request message during the WUS monitoring period.

Example 20 includes the UE of any of Examples 17 to 19, where the control signaling indicator includes a control bit of a message received via the secondary transceiver during the WUS monitoring period.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-17 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logics, logical blocks, modules, circuits, and algorithm processes described in connection with the disclosure herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include random access memory (RAM), read-only memory (ROM), electronically erasable programable ROM (EEPROM), compact disc (CD) ROM (CD-ROM), or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product or a computer-readable storage device.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted can be incorporated in the example processes that are schematically illustrated. For example, one or more additional operations can be performed before, after, simultaneously with, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. Such a threshold may be a single value or a range of values. As an illustrative example, a value may satisfy a threshold range of values if the value is between or equal to two threshold values that define the threshold range of values.

No element, act, or instruction used herein should be construed as critical or essential unless explicitly described as such. Also, as used herein, the articles “a” and “an” are intended to include one or more items and may be used interchangeably with “one or more.” It should be understood that “one or more” is equivalent to “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Similarly, the phrase “in accordance with” is intended to mean “based on or otherwise in association with” unless explicitly stated otherwise.

The previous description of the disclosure is provided to enable any person skilled in the art to make or use the disclosure. Various modifications to the implementations described in this disclosure may be readily apparent to those skilled in the art, and the generic principles defined herein may be applied to other variations without departing from the scope of this disclosure. Thus, the disclosure is not intended to be limited to the examples and designs described herein but is to be accorded the widest scope consistent with the principles and novel features disclosed herein.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories that store code and are coupled with the one or more processors, the processing system configured to cause the UE to:
receive, via a primary transceiver of the UE and from a network node, a configuration associated with a secondary transceiver of the UE;
identify, in accordance with the configuration, a first parameter value that indicates a message type and a second parameter value that indicates uplink (UL) control information; and
transmit, via the secondary transceiver, to the network node and during a wake-up signal (WUS) monitoring period, a UL transmission signal selected, in accordance with the first parameter value and the second parameter value, from one or more predefined transmission signals.

2. The UE of claim 1, wherein:
each of the one or more predefined transmission signals is capable of being decoded without frequency demodulation at a receiver; and
the message type corresponds to one of a buffer status report, a beam failure recovery message, or a power headroom report.

3. The UE of claim 1, wherein:
the first parameter value indicates an index value of a mathematical sequence; and
the second parameter value indicates a cyclic shift applied to the mathematical sequence.

4. The UE of claim 3, wherein:
the mathematical sequence is a Zadoff Chu (ZC) sequence; and
the first parameter value indicates a root sequence index of the ZC sequence.

5. The UE of claim 3, wherein:
the mathematical sequence is a maximum length sequence (m-sequence); and
the first parameter value indicates a primitive polynomial of the m-sequence.

6. The UE of claim 1, wherein:
the first parameter value indicates at least one first subcarrier of a first set of subcarriers;
the second parameter value indicates at least one second subcarrier of a second set of subcarriers; and
the UL transmission signal is transmitted via the at least one first subcarrier and the at least one second subcarrier.

7. The UE of claim 1, wherein the processing system is further configured to cause the UE to:
receive, via the secondary transceiver and during the WUS monitoring period, a downlink (DL) signal selected, in accordance with a third parameter value and a fourth parameter value, from the one or more predefined transmission signals;
identify, in accordance with the configuration, a DL message type associated with the third parameter value and DL control information associated with the fourth parameter value; and
adjust, in accordance with the DL message type being a timing advance command, transmission times of one or more additional UL transmission signals during the WUS monitoring period in accordance with the DL control information.

8. The UE of claim 1, wherein the processing system is further configured to cause the UE to:
store, at the one or more memories and prior to the WUS monitoring period, a plurality of samples each respectively associated with one of a plurality of UL transmission signals, each of the plurality of UL transmission signals associated with a respective first parameter that indicates a respective message type and a respective second parameter that indicates respective UL control information; and
access, during the WUS monitoring period, the one or more memories to identify a particular set of samples of the plurality of samples that are associated with the first parameter value associated with the UL transmission signal and the second parameter value associated with the UL transmission signal, wherein the UL transmission signal is transmitted in accordance with the particular set of samples.

9. A method of wireless communication by a user equipment (UE), comprising:
receiving, via a primary transceiver of the UE and from a network node, a configuration associated with a secondary transceiver of the UE;
identifying, in accordance with the configuration, a first parameter value that indicates a message type and a second parameter value that indicates uplink (UL) control information; and
transmitting, via the secondary transceiver, to the network node and during a wake-up signal (WUS) monitoring period, a UL transmission signal selected, in accordance with the first parameter value and the second parameter value, from one or more predefined transmission signals.

10. The method of claim 9, wherein:
each of the one or more predefined transmission signals is capable of being decoded without frequency demodulation at a receiver; and
the message type corresponds to one of a buffer status report, a beam failure recovery message, or a power headroom report.

11. The method of claim 9, wherein:
the first parameter value indicates an index value of a mathematical sequence; and
the second parameter value indicates a cyclic shift applied to the mathematical sequence.

12. The method of claim 11, wherein:
the mathematical sequence is a Zadoff Chu (ZC) sequence; and
the first parameter value indicates a root sequence index of the ZC sequence.

13. The method of claim 11, wherein:
the mathematical sequence is a maximum length sequence (m-sequence); and
the first parameter value indicates a primitive polynomial of the m-sequence.

14. The method of claim 9, wherein:
the first parameter value indicates at least one first subcarrier of a first set of subcarriers;
the second parameter value indicates at least one second subcarrier of a second set of subcarriers; and
the UL transmission signal is transmitted via the at least one first subcarrier and the at least one second subcarrier.

15. The method of claim 9, further comprising:
receiving, via the secondary transceiver and during the WUS monitoring period, a downlink (DL) signal selected, in accordance with a third parameter value and a fourth parameter value, from the one or more predefined transmission signals;
identifying, in accordance with the configuration, a DL message type associated with the third parameter value and DL control information associated with the fourth parameter value; and
adjusting, in accordance with the DL message type being a timing advance command, transmission times of one or more additional UL transmission signals during the WUS monitoring period in accordance with the DL control information.

16. The method of claim 9, further comprising:
storing, at a memory of the UE and prior to the WUS monitoring period, a plurality of samples each respectively associated with one of a plurality of UL transmission signals, each of the plurality of UL transmission signals associated with a respective first parameter that indicates a respective message type and a respective second parameter that indicates respective UL control information; and
accessing, during the WUS monitoring period, the memory to identify a particular set of samples of the plurality of samples that are associated with the first parameter value associated with the UL transmission signal and the second parameter value associated with the UL transmission signal, wherein the UL transmission signal is transmitted in accordance with the particular set of samples.

17. A user equipment (UE) for wireless communication, comprising:
a processing system that includes one or more processors and one or more memories that store code and are coupled with the one or more processors, the processing system configured to cause the UE to:
receive, via a secondary transceiver of the UE and from a network node, during a wake-up signal (WUS) monitoring period when a primary transceiver of the UE is powered down, a control signaling indicator that indicates whether control signaling is to be communicated by the network node;
receive, via the secondary transceiver and from the network node, during the WUS monitoring period and in accordance with the control signaling indicator indicating that the control signaling is to be communicated, a downlink (DL) control signal indicating a timing advance command;
identify, in accordance with a configuration associated with the secondary transceiver, a timing advance parameter value associated with a parameter value of the DL control signal; and
adjust, in accordance with the timing advance parameter value, a transmission time associated with one or more uplink (UL) transmission signals via the secondary transceiver and during the WUS monitoring period.

18. The UE of claim 17, wherein the processing system is further configured to cause the UE to:
transmit, via the secondary transceiver and during the WUS monitoring period, a physical random access channel (PRACH) preamble, wherein the control signaling indicator is received in accordance with transmission of the PRACH preamble.

19. The UE of claim 18, wherein the PRACH preamble is initiated in accordance with:
a periodic schedule;
the configuration; or
receipt of a request message during the WUS monitoring period.

20. The UE of claim 17, wherein the control signaling indicator includes a control bit of a message received via the secondary transceiver during the WUS monitoring period.
